(19) United States
(12) Patent Application Publication
(10) Pub. No.: US 2025/0182219 A1
(43) Pub. Date: Jun. 5, 2025

(54) ARTIFICIAL INTELLIGENCE (AI)-POWERED PROFESSIONAL NETWORKING PLATFORM WITH ENHANCED MATCHING

(71) Applicant: EPIQ CREATIVE GROUP, INC., Edison, NJ (US)

(72) Inventors: Scott Lebwohl, Edison, NJ (US); William McGlade, Edison, NJ (US)

(21) Appl. No.: 18/968,195

(22) Filed: Dec. 4, 2024

Related U.S. Application Data
(60) Provisional application No. 63/605,690, filed on Dec. 4, 2023.

(51) Int. Cl. G06Q 50/00; G06Q 10/1093; H04L 67/306

(52) U.S. Cl. CPC G06Q 50/01; G06Q 10/1093; H04L 67/306

(57) ABSTRACT

One embodiment provides a method comprising collecting explicit user data relating to a user associated with an in-person event, and extrapolating implicit user data relating to the user from user interactions and content engagement patterns of the user. The method further comprises generating a user profile for the user by integrating the explicit user data with the implicit user data, and dynamically updating the user profile based on real-time data. The method further comprises generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

### CROSS REFERENCE TO RELATED APPLICATIONS

This application claims priority from U.S. Provisional Patent Application Ser. No. 63/605,690, filed on Dec. 4, 2023, all incorporated herein by reference.

### TECHNICAL FIELD

One or more embodiments relate generally to networking platforms, and in particular, a method and system for artificial intelligence (AI)-powered professional networking with enhanced matching.

### BACKGROUND

Professional networking platforms have become increasingly popular for individuals and businesses seeking to connect in-person with relevant professionals in their respective fields. In the current digital landscape, however, professional networking systems and matchmaking algorithms often lack the sophistication required to create meaningful and lasting connections between professionals, as well as make precise and effective matches based on nuanced professional criteria and preferences. Conventional professional networking platforms also struggle to dynamically adapt to the changing or evolving needs and preferences of users, leading to suboptimal professional networking experiences and limiting their effectiveness in fostering successful professional connections.

While some conventional professional networking platforms attempt to match users based on basic criteria, the complex nature of professional relationships demands a more refined and intelligent approach to networking.

### SUMMARY

One embodiment provides a method comprising collecting explicit user data relating to a user associated with an in-person event, and extrapolating implicit user data relating to the user from user interactions and content engagement patterns of the user. The method further comprises generating a user profile for the user by integrating the explicit user data with the implicit user data, and dynamically updating the user profile based on real-time data. The method further comprises generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

Another embodiment provides a system comprising at least one processor and a non-transitory processor-readable memory device storing instructions that when executed by the at least one processor causes the at least one processor to perform operations. The operations include collecting explicit user data relating to a user associated with an in-person event, and extrapolating implicit user data relating to the user from user interactions and content engagement patterns of the user. The operations further include generating a user profile for the user by integrating the explicit user data with the implicit user data, and dynamically updating the user profile based on real-time data. The operations further include generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

One embodiment provides a non-transitory processor-readable medium that includes a program that when executed by a processor performs a method. The method comprises collecting explicit user data relating to a user associated with an in-person event, and extrapolating implicit user data relating to the user from user interactions and content engagement patterns of the user. The method further comprises generating a user profile for the user by integrating the explicit user data with the implicit user data, and dynamically updating the user profile based on real-time data. The method further comprises generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

These and other features, aspects and advantages of the present invention will become understood with reference to the following description, appended claims and accompanying figures.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an example computing architecture for artificial intelligence (AI)-powered professional networking, in one or more embodiments;

FIG. 2 illustrates an example server-side professional networking system, in one or more embodiments;

FIG. 3 illustrates an example client-side professional networking application, in one or more embodiments;

FIG. 4 illustrates an example wireframe of the AI-driven professional networking platform, in one or more embodiments;

FIG. 5A illustrates an example sequence of GUIs within the application a user is presented with at login, in one or more embodiments;

FIG. 5B illustrates an example events page displayed within the application, in one or more embodiments;

FIG. 5C illustrates an example community page displayed within the application, in one or more embodiments;

FIG. 5D illustrates an example group page displayed within the application, in one or more embodiments;

FIG. 5E illustrates an example marketplace page displayed within the application, in one or more embodiments;

FIG. 5F illustrates an example vendor page displayed within the application, in one or more embodiments;

FIG. 5G illustrates an example event page displayed within the application, in one or more embodiments;

FIG. 5H illustrates an example event registration page displayed within the application, in one or more embodiments;

FIG. 5I illustrates an example menu page displayed within the application, in one or more embodiments;

FIG. 5J illustrates an example learning hub page displayed within the application, in one or more embodiments;

FIG. 5K illustrates an example job board page displayed within the application, in one or more embodiments;

FIG. 5L illustrates an example mentor board page displayed within the application, in one or more embodiments;

FIG. 5M illustrates an example resources page displayed within the application, in one or more embodiments;

FIG. 6A illustrates an example login screen displayed within the application, in one or more embodiments;

FIG. 6B illustrates an example home screen displayed within the application, in one or more embodiments;

FIG. 6C illustrates an example user profile page displayed within the application, in one or more embodiments;

FIG. 6D illustrates an example chats page displayed within the application, in one or more embodiments;

FIG. 6E illustrates an example individual chat page displayed within the application, in one or more embodiments;

FIG. 6F illustrates an example events page displayed within the application, in one or more embodiments;

FIG. 6G illustrates an example QR code page displayed within the application, in one or more embodiments;

FIG. 6H illustrates an example recommendation page displayed within the application, in one or more embodiments;

FIG. 6I illustrates another example recommendation page displayed within the application, in one or more embodiments;

FIG. 6J illustrates an example sign up page displayed within the application, in one or more embodiments;

FIG. 6K illustrates an example notifications page displayed within the application, in one or more embodiments;

FIG. 7 is a flowchart of an example process for AI-driven professional networking, in one or more embodiments; and

FIG. 8 is a high-level block diagram showing an information processing system comprising a computer system useful for implementing the disclosed embodiments.

The detailed description explains the preferred embodiments of the invention together with advantages and features, by way of example with reference to the drawings.

### DETAILED DESCRIPTION

One or more embodiments relate generally to networking platforms, and in particular, a method and system for artificial intelligence (AI)-powered professional networking with enhanced in-person event driven matching. One embodiment provides a method comprising collecting explicit user data relating to a user associated with an event, and extrapolating implicit user data relating to the user from user interactions and content engagement patterns of the user. The method further comprises generating a user profile for the user by integrating the explicit user data with the implicit user data, and dynamically updating the user profile based on real-time data. The method further comprises generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

Another embodiment provides a system comprising at least one processor and a non-transitory processor-readable memory device storing instructions that when executed by the at least one processor causes the at least one processor to perform operations. The operations include collecting explicit user data relating to a user associated with an in-person event, and extrapolating implicit user data relating to the user from user interactions and content engagement patterns of the user. The operations further include generating a user profile for the user by integrating the explicit user data with the implicit user data, and dynamically updating the user profile based on real-time data. The operations further include generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

One embodiment provides a non-transitory processor-readable medium that includes a program that when executed by a processor performs a method. The method comprises collecting explicit user data relating to a user associated with an in-person event, and extrapolating implicit user data relating to the user from user interactions and content engagement patterns of the user. The method further comprises generating a user profile for the user by integrating the explicit user data with the implicit user data, and dynamically updating the user profile based on real-time data. The method further comprises generating, via a matchmaking algorithm utilizing one or more machine learning models, a professional match recommendation for the user based on the user profile and one or more additional user profiles of one or more additional users. The professional match recommendation suggests the user professionally network with a different user having one or more attributes that are complementary to the user.

For expository purposes, the term “professional” as used herein generally refers to an individual over 17 years of age or an entity providing a service (e.g., freelancers, service providers, photographers, florists, videographers, etc.), engaged in a business or an industry (e.g., entrepreneurs, exhibitors, sponsors, event organizers, show organizers, associations, vendors such as caterers, venues, etc.), or engaged in, relating to, belonging to, or qualified in, a profession (e.g., lawyers, doctors, accountants, etc.).

For expository purposes, the term “professional match” as used herein generally refers to a match between two professionals. The terms “professional match”, “professional connection”, and “professional collaboration” are used interchangeably herein.

For expository purposes, the term “professional match recommendation” as used herein generally refers to a recommendation of a professional match, i.e., a matchmaking suggestion. The terms “professional match recommendation”, “potential professional match”, “recommended professional connection”, and “recommended professional collaboration” are used interchangeably herein.

One or more embodiments provide an AI-powered professional networking platform which utilizes an enhanced matchmaking algorithm that overcomes the limitations of luck based networking at in-person events and conventional professional networking platforms. By incorporating advanced machine learning techniques, dynamic user profiling, and real-time adaptive recommendations, the platform revolutionizes the way professionals connect, interact, and collaborate by enhancing the accuracy of professional matching. Specifically, the enhanced matchmaking algorithm enables users to expand their professional networks and foster meaningful and enduring professional relationships, leading to increased opportunities and productivity within their respective professional circles.

One or more embodiments provide an advanced/enhanced professional networking and matchmaking system that revolutionizes the way professionals connect and collaborate. By integrating a comprehensive data-driven approach with sophisticated matchmaking algorithms, the system enhances the accuracy and relevance of recommendations, facilitating impactful networking opportunities and fostering meaningful professional relationships. With a focus on adaptive learning and user-centric matchmaking, the system empowers professionals to build robust and mutually beneficial networks tailored to their specific industry or professional needs (i.e., requirements) and networking or career goals or objectives.

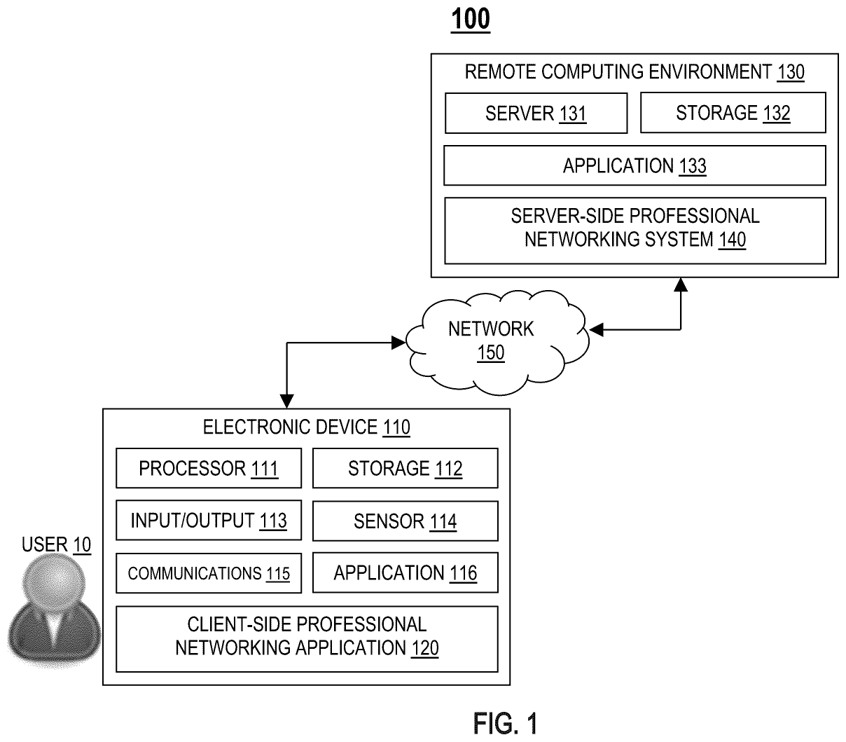

FIG. 1 is an example computing architecture 100 for AI-powered professional networking, in one or more embodiments. The computing architecture 100 comprises at least one electronic device 110. The electronic device 110 includes resources, such as one or more processor units 111 and one or more storage units 112. One or more applications 116 may execute/operate on the electronic device 110 utilizing the resources of the electronic device 110.

In one embodiment, the one or more applications 116 include a client-side professional networking application 120. As described in detail later herein, a user 10 (e.g., a professional) may utilize the application 120 to access an AI-powered professional networking platform where the user 10 may connect, interact, and collaborate with other users 10 (e.g., other professionals) to maximize their networking potential and business and career opportunities.

Examples of a user 10 include, but is not limited to, event attendees, professionals in various industries, exhibitors, sponsors, vendors, event organizers, suppliers, individuals interested in professional growth, businesses and organizations, event industry service providers, mentors, mentees, job seekers, employers, etc.

Examples of an electronic device 110 include, but is not limited to, a mobile electronic device (e.g., an optimal frame rate tablet, a smart phone, a laptop, etc.), a wearable device (e.g., a smart watch, a smart band, a head-mounted display, smart glasses, etc.), a desktop computer, a gaming console, an Internet of things (IoT) device, a television (TV) (e.g., a smart TV), etc.

In one embodiment, the electronic device 110 comprises one or more input/output (I/O) units 113 integrated in or coupled to the electronic device 110. In one embodiment, the one or more I/O units 113 include, but are not limited to, a physical user interface (PUI) and/or a graphical user interface (GUI), such as a remote control, a keyboard, a keypad, a touch interface, a touch screen, a knob, a button, a display screen, etc. In one embodiment, the user 10 can utilize at least one I/O unit 113 to configure one or more settings, provide user input (e.g., user preferences, accepting or declining a recommended professional match), etc.

In one embodiment, the electronic device 110 comprises one or more sensor units 114 integrated in or coupled to the electronic device 110, such as, but not limited to, a camera, a microphone, a GPS, a motion sensor, etc.

In one embodiment, the electronic device 110 comprises a communications unit 115 configured to exchange data with a remote computing environment 130, over a communications network/connection 150 (e.g., a wireless connection such as a Wi-Fi connection or a cellular data connection, a wired connection, or a combination of the two). The communications unit 115 may comprise any suitable communications circuitry operative to connect to a communications network and to exchange communications operations and media between the electronic device 110 and other devices connected to the same communications network 150. The communications unit 115 may be operative to interface with a communications network using any suitable communications protocol such as, for example, Wi-Fi (e.g., an IEEE 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, TCP-IP, or any other suitable protocol.

In one embodiment, the one or more applications 116 may further include one or more software mobile applications 116 loaded onto or downloaded to the electronic device 110, such as a camera application, a social media application, etc. A software mobile application 116 on the electronic device 110 may exchange data with the client-side digital asset application 120.

In one embodiment, the remote computing environment 130 includes resources, such as one or more servers 131 and one or more storage units 132. One or more applications 133 that provide higher-level services may execute/operate on the remote computing environment 130 utilizing the resources of the remote computing environment 130.

In one embodiment, the one or more applications on the remote computing environment 130 include a server-side professional networking system 140 providing the AI-powered professional networking platform. The client-side professional networking application 120 and the system 140 are configured to interface and exchange data with each other. As described in detail later herein, the system 140 implements an enhanced matchmaking algorithm (i.e., matching algorithm) that utilizes state-of-the-art machine learning techniques to provide users 10 with timely and contextually relevant recommendations for professional matching, thereby ensuring the users 10 are consistently matched with the most suitable and opportune professional connections.

In one embodiment, the remote computing environment 130 provides an online platform for hosting one or more online services (e.g., the server-side professional networking system 140, etc.) and/or distributing one or more software mobile applications 116. For example, the client-side professional networking application 120 may be loaded onto or downloaded to the electronic device 110 from the remote computing environment 130 that maintains and distributes updates for the application 120. In another embodiment, the client-side professional networking application 120 may be downloaded to the electronic device 110 from an application marketplace (e.g., App Store, Play Store, etc.) executing/operating on a different remote computing environment.

In one embodiment, the remote computing environment 130 may comprise a cloud computing environment providing shared pools of configurable computing system resources and higher-level services (e.g., data analytics). In another embodiment, the remote computing environment 130 may comprise an edge computing environment providing more safe, scalable, and reliable data processing and computation for display color temperature adaptation modeling and/or display brightness adaptation modeling.

In one embodiment, the application 120 is integrated into existing event and registration applications, services, and tools. In one embodiment, the application 120 works in collaboration with existing event and registration applications, services, and tools. In one embodiment, the application 120 is a standalone application, independent of existing event and registration applications, services, and tools.

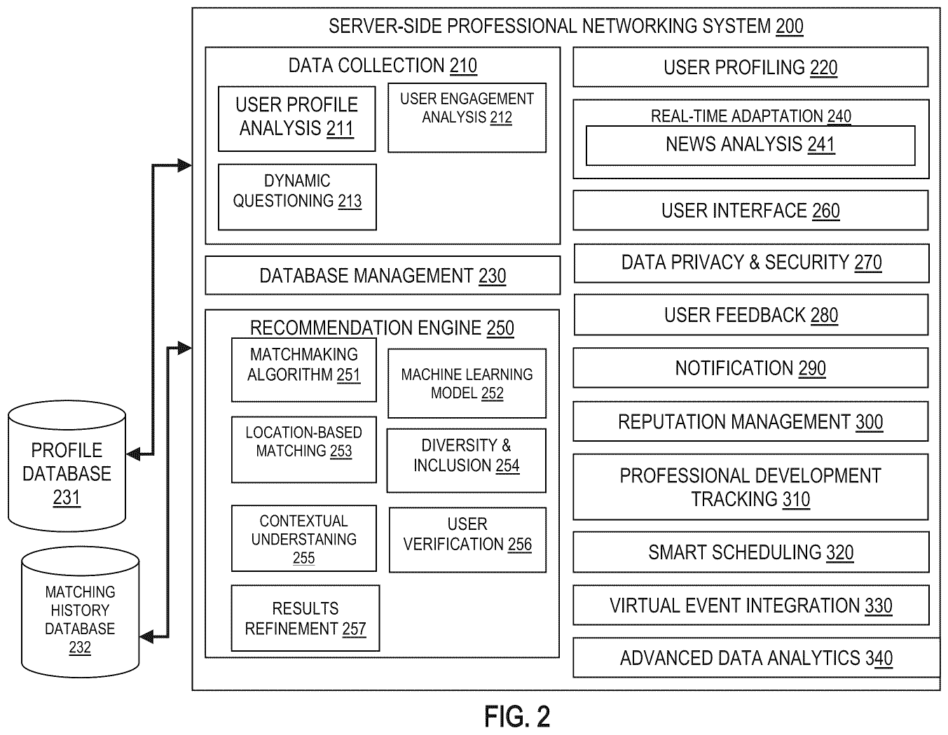

FIG. 2 illustrates an example server-side professional networking system 200, in one or more embodiments. The system 200 provides an AI-powered professional networking platform which a user 10 can access via a client-side professional networking application 120. In one embodiment, the system 200 is deployed at a remote computing environment 130. For example, the system 200 is integrated into, or implemented as part of, the server-side digital professional networking system 140 in FIG. 1.

In one embodiment, the professional networking system 200 comprises a data collection system 210 implementing a multi-layered data collection mechanism. Specifically, the system 210 is configured to collect explicit and implicit user data relating to one or more users 10, resulting in a comprehensive user dataset.

In one embodiment, user data relating to a user 10 is collected from one or more electronic devices 110 (FIG. 1) of the user 10. The explicit user data collected by the system 210 includes user-provided data (i.e., data provided/inputted by the one or more users 10). The implicit user data collected by the system 210 includes user preferences (e.g., communication preferences, matching or networking preferences, etc.) and user behaviors that the system 210 extrapolates from user interactions and engagement patterns (e.g., content engagement patterns, communication patterns, etc.) of the one or more users 10. Therefore, the system 200 leverages the multi-layered data collection mechanism to capture and analyze various facets of user behavior, user preferences, and professional expertise. A user dataset from the system 210 provides a comprehensive understanding of user preferences and user behaviors.

In one embodiment, user data relating to a professional (i.e., a user 10) the data collection system 210 collects includes, but is not limited to, one or more job positions/titles (i.e., one or more job roles), one or more work experiences, one or more keywords of interest, one or more tags, one or more events of interest, one or more memberships in one or more organizations, etc.

In one embodiment, the data collection system 210 includes a user profile analysis unit 211. For each user 10, the unit 211 is configured to gather and analyze corresponding user-provided demographic data to determine corresponding user profile information such as, but not limited to, professional expertise, industry experience, educational background, current job position/title (i.e., current job role), company size, geographic location, etc. For each user 10, the unit 211 is further configured to determine one or more user preferences provided/set by the user 10 such as, but not limited to, types of professional connections the user 10 is interested in, types of events the user 10 is interested in, etc.

In one embodiment, the data collection system 210 utilizes natural language processing (NLP), behavioral analysis, sentiment analysis, and/or user engagement analysis to capture user interactions and engagement patterns, and, in turn, extract/extrapolate implicit insights from user interactions and user behaviors. For example, in one embodiment, implicit insight such as nuanced user preferences, communication styles, level of user interaction, and communication responsiveness (i.e., user response times) are extracted/extrapolated.

In one embodiment, the data collection system 210 includes a user engagement analysis unit 212 that implements user engagement analysis, user behavioral analysis, and/or user sentiment analysis. In one embodiment, for user behavioral analysis, the unit 212 is configured to, for each user 10, track and analyze in-app user behavior as well as external online user behavior of the user 10. In-app user behavior includes online user interactions and user preferences settings of a user 10 that are within a client-side professional networking application 120, such as clicks, views, and engagement with one or more other users 10 or content. External online user behavior includes online user interactions of a user 10 that are outside of a client-side professional networking application 120. External online user behavior may be obtained from cookies and/or third-party data providers.

In one embodiment, the user engagement analysis unit 212 captures in-app user behavior through comprehensive event logging and user journey tracking within a client-side professional networking application 120. In one embodiment, the unit 212 utilizes NLP for context extraction, analyzing user-generated content, and communication context. In one embodiment, the unit 212 analyzes communication patterns for user-centric adaptation, identifying preferred communication channels, communication styles, and/or response patterns.

In one embodiment, for user sentiment analysis, the unit 212 is configured to, for each user 10, assess or determine an emotional tone (i.e., user sentiment) and context of one or more user interactions of the user 10. Based on user sentiment of a user 10, the system 200 may provide emotionally intelligent professional match recommendations for the user 10 that facilitate meaningful professional connections.

In one embodiment, for user engagement analysis, the unit 212 is configured to, for each user 10, assess a level of user interaction and/or communication responsiveness (i.e., user response times) of the user 10. This allows the system 200 to construct detailed user profiles, refine the user profiles, and/or refine professional match recommendations.

In one embodiment, the data collection system 210 cleans and pre-processes some user data collected. For example, in one embodiment, the system 210 implements NLP to clean and pre-process text user data collected. As another example, in one embodiment, the system 210 standardizes data formats for job positions/titles, work experiences and other textual user data collected to ensure consistency among multiple users 10.

In one embodiment, the data collection system 210 utilizes one or more large language models (LLMs) to extract features by encoding textual user data (e.g., job positions/titles) into numerical and visual vector datasets.

In one embodiment, the data collection system 210 includes a dynamic questioning unit 213. The unit 213 implements adaptive questioning by presenting users 10 with situational or random questions, and collecting user-provided responses, thereby gathering more insights into their current needs or interests.

Therefore, via the unit 212 and/or the unit 213, the data collection system 210 captures various user interaction data such as, but not limited to, content engagement patterns, communication preferences, and communication responsiveness (i.e., user response times).

In one embodiment, the professional networking system 200 comprises a user profiling unit 220 configured to dynamically generate, based on a user dataset (e.g., from the data collection system 210), one or more comprehensive or intricate user profiles for one or more users 10 by integrating explicit user data relating to the users 10 (e.g., professional expertise, industry experience, educational background, certifications, professional accomplishments, etc.) with implicit user data relating to the users 10 (e.g., user behaviors, content engagement patterns, communication preferences, communication styles, preferred networking frequency etc.). By amalgamating explicit user-provided data with implicit insights extracted from user interactions, the unit 220 constructs detailed and dynamic user profiles that provide the system 200 with the foundation for precise and effective matchmaking. For example, in one embodiment, the unit 220 generates dynamic user profiles by integrating explicit user data such as, but not limited to, recent certifications and professional accomplishments. As another example, in one embodiment, the unit 220 generates nuanced user profiles by incorporating implicit user data such as, but not limited to, communication styles and preferred networking frequency. User profiles from the unit 220 provide the system 200 with a comprehensive understanding of user preferences and user behaviors such as, but not limited to, career goals or objectives (i.e., career aspirations), networking goals or objectives, etc.

In one embodiment, the user profiling unit 220 implements user profile indexing. For example, in one embodiment, the unit 220 generates a searchable index of user profiles, wherein each user profile is represented by a vector (e.g., a numerical and/or visual vector dataset) that summarizes its characteristics.

In one embodiment, the professional networking system 200 comprises a database management unit 230 configured to: (1) maintain one or more profile databases 231 including one or more user profiles (e.g., from the user profiling unit 220) of one or more users 10, vendor details of one or more vendors, and event details of one or more events, and (2) maintain one or more matching history databases 232 including, for each user 10, one or more corresponding past professional matches and one or more corresponding past user interactions. For example, in one embodiment, the unit 220 creates a per user matching history database 232 which identifies, for a particular user 10, one or more other users 10 that the user 10 interacted with (i.e., crossed paths with) at an event.

New professional match recommendations for a user 10 may be based at least in part on one or more past professional matches and/or one or more past user interactions of the user 10. In one embodiment, each profile database 231 and each matching history database 232 is implemented on at least one storage unit 132 (FIG. 1) of the remote computing environment 130 (FIG. 1).

In one embodiment, the professional networking system 200 comprises a real-time adaptation system 240. The system 240 implements a real-time adaptive mechanism that continuously refines/updates one or more user profiles (e.g., from the user profiling unit 220 and/or the one or more profile databases 231) of one or more users 10 based on one or more evolving user preferences and/or one or more emerging industry or professional trends in one or more industries or professional domains (i.e., professional communities or professional landscapes) relevant to the one or more users 10. For example, in one embodiment, the system 240 dynamically adjusts a user profile for a user 10 based on real-time user data relating to the user 10 and/or one or more real-time user interactions of the user 10. This adaptive mechanism allows the system 200 to provide users 10 with timely (i.e., up-to-date) and the most contextually relevant professional match recommendations, thereby ensuring the relevance and accuracy of the recommendations, such that the users 10 are consistently matched with the most suitable and opportune professional connections. For example, by continuously updating user profiles based on real-time data inputs (e.g., user-provided data) and user interactions, the system 200 is able to provide professional match recommendations that account for recent career developments and professional networking activities.

In one embodiment, the system 240 dynamically adjusts one or more professional match recommendations for a user 10 based on one or more real-time user interactions of the user 10 and/or one or more emerging industry or professional trends in one or more industries or professional domains relevant to the user 10. This allows the system 200 to provide users 10 with adjusted professional match recommendations that factor into account real-time market dynamics and emerging industry or professional demands via web-based data pulls such as, but not limited to, Really Simple Syndication (RSS) feeds.

In one embodiment, the system 240 dynamically updates one or more professional match recommendations for a user 10 in response to user feedback from the user 10 (e.g., collected via a user feedback engine 280) and current industry or professional needs, thereby ensuring relevancy and accuracy of the recommendations.

In one embodiment, the system 240 continuously refines a user profile for a user 10 in response to user feedback from the user 10 (e.g., collected via the user feedback engine 280) and communication preferences of the user 10.

In one embodiment, the user profiling unit 220 dynamically adjusts user preferences of a user 10 based on user feedback from the user 10 (e.g., collected via the user feedback engine 280) and communication preferences of the user 10, thereby ensuring a user-centric approach to professional networking and fostering a highly personalized user experience.

As another example, in one embodiment, the real-time adaptation system 240 includes a real-time news analysis unit 241 configured to parse and analyze, utilizing NLP, real-time news data to identify one or more trending topics or events in an industry or a professional domain relevant to a user 10 (i.e., emerging industry or professional trends, mergers and acquisitions (M&A) activity, updates relating to the Federal Reserve, updates relating to one or more stock markets and/or stock market indices, etc.).

In one embodiment, the system 200 comprises an advanced recommendation engine 250 implementing an enhanced and multi-dimensional AI-driven weighted matchmaking algorithm 251 to suggest or recommend relevant professional connections, networking opportunities, and/or networking activities for users 10 based on shared interests, complementary skill sets, and mutual networking or career goals or objectives.

For example, in one embodiment, the matchmaking algorithm 251 is configured to: (1) identify, utilizing one or more state-of-the-art machine learning models 252, intricate patterns and correlations within a user dataset (e.g., from the data collection system 210) for one or more users 10, and (2) generate, based on the data identified, curated/personalized recommendations for the one or more users 10. In one embodiment, the one or more machine learning models 252 include one or more deep learning models, such as, but not limited to, one or more LLMs. In one embodiment, the data identified includes cross-industry collaborative patterns.

In one embodiment, the matchmaking algorithm 251 implements predictive analytics/modeling utilizing artificial intelligence (e.g., the one or more machine learning models 252) to anticipate/predict potential professional synergies and collaboration opportunities, facilitate strategic partnerships, and foster collaborative endeavors within a professional domain. For example, in one embodiment, the matchmaking algorithm 251 predicts future/potential recommendations (i.e., potential professional matches or potential future collaborations), as well as identifies emerging industry or professional trends, thereby providing users 10 with invaluable industry or professional insights into their respective industries or professional domains and strategic business, career, or other networking opportunities. The algorithm 251 provides users 10 with AI-powered personalized business insights, trend analysis, and recommendations based on user profiles and industry developments.

In one embodiment, the matchmaking algorithm 251 utilizes AI (e.g., the one or more machine learning models 252) to analyze user data for a user 10 to provide personalized networking recommendations that enhance the user experience of the user 10, such as recommending sessions, workshops, and networking opportunities relevant to the user 10 based on past user behaviors, job titles, and interests of the user 10.

In one embodiment, the matchmaking algorithm 251 utilizes AI (e.g., the one or more machine learning models 252) to facilitate matchmaking among different types of users 10—such as attendees to an event, exhibitors at the event, and suppliers at the event—based on preferences, interests, and professional goals, thereby enhancing networking opportunities among the users 10.

In one embodiment, the recommendation engine 250 includes a contextual understanding unit 255 configured to analyze, utilizing the one or more machine learning models 252, industry-specific or profession-specific terminology and current market dynamics to tailor recommendations for a user 10 to a particular industry or professional domain relevant to the user. This allows the matchmaking algorithm 251 to incorporate a contextual understanding of industry-specific/profession-specific terminology and industry or professional trends, enabling the engine 250 to provide nuanced and specialized recommendations that are tailored to specific industry or professional sectors or fields. For example, the nuanced and specialized recommendations may include proactive networking opportunities. The recommendation engine 250 is able to refine, via the contextual understanding unit 255, professional matches based on contextual understanding of industry-specific terminology, incorporating specialized industry jargon and evolving professional language trends.

In one embodiment, the recommendation engine 250 incorporates an industry-specific or profession-specific matchmaking algorithm 251 for an industry or professional domain relevant to a user 10. Therefore, the engine 250 is able to consider the unique requirements and dynamics of different industries or professional domains, and in turn provide tailored recommendations that account for industry-specific or profession-specific nuances and demands.

By leveraging the one or more machine learning models 252, the matchmaking algorithm 251 enhances the accuracy and relevance of recommendations, predicts potential professional matches or potential future collaborations, and identifies emerging industry or professional trends, thereby providing users 10 with timely and precise recommendations and invaluable predictive insights into their respective industries or professional domains (i.e., professional communities or professional landscapes). By incorporating intelligent decision-making processes and predictive analytics, the recommendation engine 250 facilitates seamless and strategic professional networking, enabling professionals to forge valuable partnerships and cultivate a thriving professional ecosystem. For example, the matchmaking algorithm 251 implements predictive modeling and trend analysis to anticipate future industry demands and market shifts, enabling users 10 to proactively build strategic professional connections aligned with anticipated industry developments.

As another example, the matchmaking algorithm 251 predicts future recommendations (i.e., potential professional matches or potential future collaborations) based on user feedback (e.g., collected via the user feedback unit 280) as well as historical/past success metrics/rates that are indicative of whether past recommendations were successful professional matches (i.e., user success stories and/or user networking achievements). The matchmaking algorithm 251 is continuously fine-tuned/refined based on the user feedback and the historical/past success metrics/rates.

In one embodiment, the matchmaking algorithm 251 implements a user-centric approach to matchmaking that prioritizes user preferences and networking or career goals or objectives when the system 200 generates recommendations. Therefore, a user 10 can specify or set specific networking or career goals or objectives for the system 200 to consider.

In one embodiment, the recommendation engine 250 includes a location-based matching unit 253 that implements geo-fencing to generate for a user 10 one or more recommendations of a local professional connection, a vendor, or an event based on location data of the user 10.

In one embodiment, the recommendation engine 250 includes a diversity and inclusion unit 254 that promotes the formation of diverse professional networks by actively recommending and encouraging, via recommendations, professional connections between users 10 across diverse backgrounds, demographics, and industries. The unit 254 ensures inclusive matchmaking for users 10 from varied backgrounds, demographics, geographical attributes (locations, cities, regions, countries, etc.), and industries, thereby fostering a professional networking environment of equal opportunity and diversity in collaboration. The unit 254 further facilitates equitable professional networking environments to ensure fair representation and opportunities for professionals from underrepresented communities. By prioritizing user-centric matchmaking and fostering diverse and inclusive professional networks, the system 200 cultivates a professional networking environment conducive to the growth and success of professionals from all backgrounds and disciplines.

In one embodiment, the matchmaking algorithm 251 factors into account not only professional expertise but also cultural and social compatibilities between users 10 to facilitate effective and harmonious professional relationships between the users 10.

In one embodiment, the recommendation engine 250 adapts to user behaviors in real-time, adjusting the frequency and relevance of recommendations based on user engagement patterns and user preferences

In one embodiment, the recommendation engine 250 includes a user verification unit 256 configured to ensure the authenticity and credibility of user profiles, thereby reducing the likelihood of fraudulent or misleading professional networking activities via in-house developments or external partnerships with security vetting services such as, but not limited to, CLEAR.

In one embodiment, the recommendation engine 250 includes a results refinement unit 257 configured to filter and/or rank professional match recommendation for a user 10 by applying one or more filters and/or ranking criteria to the recommendations, wherein the resulting filtered and/or ranked recommendations is presented to the user 10. The one or more filters and/or ranking criteria may be based on location, event, or specific user preferences.

In one embodiment, the results refinement unit 257 provides a collaborative filtering mechanism that considers professional networking activities and professional connections among similar users 10; the recommendation engine 250 may utilize this mechanism to provide additional recommendations and professional networking opportunities, thereby fostering a collaborative professional networking environment.

By seamlessly integrating advanced machine learning techniques (e.g., via the matchmaking algorithm 251), dynamic user profiling (e.g., via the user profiling unit 220), and real-time adaptive recommendations (e.g., via the real-time adaptation system 240), the system 200 provides a transformative user experience that transcends the limitations of conventional networking platforms. The system 200 provides users 10 with the ability to foster genuine and lasting professional relationships, while keeping pace with rapidly evolving professional domains (i.e., professional communities or professional landscapes), thereby positioning it as an indispensable tool for professionals seeking to maximize their networking potential and business and career opportunities.

As stated above, in one embodiment, the one or more machine learning models 252 include one or more LLMs. The use of LLM-driven technology offers a level of precision, adaptability, and scalability that surpasses human capabilities within the context of live, proximity-based professional networking at events. The system 200 leverages the ability of an LLM to process vast data points, identify nuanced trends, and dynamically adjust in real-time.

For example, an LLM offers data processing scale and speed. The LLM's ability to process hundreds of attributes, behaviors, and interactions across thousands of attendees in real-time surpasses human capacity, providing contextually relevant recommendations at a scale and speed that cannot be achieved by human facilitators. As another example, an LLM offers consistency and scalability. Unlike human matchmakers who may vary in judgment and scale poorly, the LLM provides consistent, objective, and scalable recommendations across events, ensuring a uniform quality of experience regardless of event size or complexity. In one embodiment, the system 200 utilizes an LLM for complex trait integration for matchmaking. Specifically, the matchmaking algorithm 251 leverages the LLM's ability to simultaneously evaluate over fifty unique user traits and attributes-including career history, networking or career goals or objectives, behavioral trends, communication styles, and preferences- and continuously learn from new data to refine professional match recommendations. Human intelligence would struggle to instantly analyze such a multi-dimensional data set at scale, especially in a live event environment where context and priorities are rapidly evolving.

As another example, an LLM offers behavioral insight depth and adaptiveness. The depth of insight and adaptive learning from nuanced patterns (e.g., micro-behaviors, sentiment shifts, etc.) enables the LLM to offer a hyper-personalized experience that continuously evolves, a capability that would require an impractical amount of human attention and memory. In one embodiment, the system 200 utilizes an LLM for real-time adaptive matchmaking using micro-behaviors. Specifically, the matchmaking algorithm 251 utilizes the LLM to detect and interpret micro-behaviors (e.g., pauses in communication, shifts in interaction sentiment, changes in session attendance) of users 10 in real-time, using these insights to predict and dynamically adjust recommended connections. While humans can assess individual behaviors, the LLM's capability to synthesize thousands of micro-signals concurrently and respond instantaneously provides a level of precision and context that is infeasible for a human facilitator.

In one embodiment, the system 200 utilizes an LLM for continuous contextual learning across events. Specifically, the matchmaking algorithm 251 leverages the LLM's continuous contextual learning across multiple events to build a comprehensive understanding of user networking patterns, preferences, and goals over time, and refine its professional match recommendations with each interaction. Human matchmakers lack the bandwidth and cognitive capacity to track and learn from these complex behavioral patterns at such depth and scale, making this feature uniquely valuable for event-based professional networking.

In one embodiment, the system 200 utilizes an LLM for sentiment and communication style parsing at scale. Specifically, the matchmaking algorithm 251 leverages the LLM's ability to parse sentiment and communication style from large volumes of user data (e.g., chat transcripts, event feedback, surveys, etc.) to tailor professional match recommendations based on nuanced social compatibility. While humans can recognize communication styles on an individual basis, the LLM analyzes thousands of interactions simultaneously, identifying trends and adjusting recommendations in ways that exceed human capacity and consistency.

As another example, an LLM offers predictive modeling and real-time adjustments. The predictive capabilities of the LLM, combined with its ability to recalibrate scores (e.g., similarity scores) and refine matches instantly based on live feedback, ensure that attendees receive the most relevant connections and recommendations at all times-a level of real-time responsiveness beyond human ability. In one embodiment, the system 200 utilizes an LLM for predictive matchmaking and success probability modeling. Specifically, the matchmaking algorithm 251 utilizes the LLM to calculate the probability of successful professional matches by integrating over fifty different attributes and historical data patterns, thereby optimizing professional match recommendations for outcomes such as deal closures, long-term partnerships, and high-quality professional networking experiences. Human facilitators are unable to replicate this level of predictive modeling due to cognitive limitations and the inability to process such high-dimensional data in real-time.

In one embodiment, the system 200 utilizes an LLM for high-frequency match optimization in dynamic networking environments. Specifically, the matchmaking algorithm 251 utilizes the LLM to reevaluate and update professional match recommendations every second based on changes in user behavior, event flow, and new data inputs, providing live professional match recommendations that remain relevant throughout the event. The sheer frequency and speed of these optimizations are impossible for humans to replicate, as human facilitators would struggle to process and respond to the rapid data shifts in live event settings.

In one embodiment, the system 200 utilizes an LLM for multi-variable conversation and icebreaker generation. Specifically, to implement a context-aware conversation suggestion engine, the LLM generates personalized icebreakers and conversation topics by considering hundreds of variables such as shared goals, industry trends, and complementary skills. Human matchmakers can only consider a limited set of variables and cannot replicate the LLM's capacity to dynamically generate thousands of conversation starters that are contextually appropriate and timely.

In one embodiment, the system 200 utilizes an LLM for proximity-based network mapping and influence analysis. Specifically, the LLM constructs proximity-based network maps, identifying high-value clusters and influential nodes in real-time to suggest optimized routes and interactions for users via event venue map wayfinding. While human intelligence can map smaller groups over time, the LLM's ability to construct these complex social graphs instantaneously using diverse data inputs (e.g., location, engagement history, interest alignment, etc.) is beyond human capability.

In one embodiment, the system 200 utilizes an LLM for trait-driven group formation and micro-community recommendations. Specifically, to implement group formation, the LLM analyzes multi-trait compatibility among attendees, suggesting high-potential groups for topic-specific networking or project collaborations. Human facilitators may be able to form basic groups but lack the capacity to analyze hundreds of traits across diverse individuals in real-time, making the LLM-driven approach significantly more precise and scalable.

In one embodiment, the system 200 utilizes an LLM for cross-event longitudinal learning and behavior forecasting. Specifically, the LLM aggregates and learns from user data across multiple events, identifying long-term behavioral patterns and forecasting future networking tendencies. This cross-event behavioral forecasting would be beyond human capability due to the cognitive load required to remember and accurately interpret data points from interactions spread across months or years.

In one embodiment, the system 200 utilizes an LLM for automated/dynamic calibration and adjustments of weights. Specifically, the LLM automatically/dynamically adjusts the weightings of various user preferences/traits (e.g., professional background, industry, company name, job position/title, location, primary networking or career goal or objective, start deal timing, go to market timing, ideal deal size, deals per year, etc.) used in determining similarity scores for matchmaking based on changing event contexts, user feedback, and historical match outcomes. Human intelligence cannot perform these complex recalibrations at scale with the same speed and precision, particularly as new data is continuously incorporated.

In one embodiment, the system 200 utilizes an LLM for intelligent fatigue and engagement level detection. Specifically, to implement engagement level and networking fatigue detection, the LLM assesses user activity patterns and adjusts professional match recommendations accordingly to prevent user burnout and to maximize user engagement. Human facilitators may notice surface-level fatigue cues but cannot assess hundreds of attendees simultaneously with such accuracy and adaptiveness.

In one embodiment, the system 200 utilizes an LLM for highly granular role-based professional match prioritization. Specifically, the LLM uses granular role-based distinctions (e.g., vendor, buyer, influencer, etc.) to prioritize professional matches for specific event contexts, ensuring optimal professional connections based on each attendee's professional role and event objectives. Human matchmakers would be unable to replicate the LLM's ability to consistently adjust these priority levels for thousands of attendees in real-time, making it uniquely suited for large-scale professional events.

In one embodiment, the system 200 utilizes an LLM for event-specific scenario simulation and impact analysis. Specifically, the LLM models various networking scenarios (e.g., attendee A meeting with vendor B under different contexts) and predicts potential outcomes, providing event organizers with actionable insights on optimizing professional networking flows. Human facilitators lack the analytical power to simulate and accurately forecast such scenarios across a large attendee base.

In one embodiment, the system 200 utilizes an LLM for automated data integration and contextual adaptation. Specifically, the LLM integrates with third-party platforms (e.g., LinkedIn®, CRM systems, etc.) to pull in contextual data and dynamically adapt professional match recommendations, providing insights that are contextually aware and continuously updated. Human matchmakers cannot process and adapt to such large data streams in real-time, making the LLM's continuous adaptation a significant technological advantage.

In one embodiment, the system 200 comprises a user interface unit 260. The unit 260 is configured to generate one or more GUIs for display to a user 10 (i.e., via the client-side professional networking application 120 running on an electronic device 110 of the user 10). Each GUI represents a screen (e.g., home screen) or page (e.g., user profile page) for display within the application 120. For example, in one embodiment, the unit 260 receives professional match recommendations for a user 10 (e.g., from the recommendation engine 250), and generates one or more GUIs including the recommendations for display on an electronic device 10 of the user 10. The one or more GUIs presents the recommendations to the user 10 in an intuitive and engaging manner, allowing the user 10 to easily connect and interact with other users 10 who are included in the recommendations.

In one embodiment, the system 200 comprises a data privacy and security unit 270 that implements one or more user data protection measures (or one or more data privacy and security protocols) to ensure the confidentiality and protection of user data, as well as comply with industry standards and regulations and/or global data privacy and security regulations. For example, in one embodiment, the unit 270 utilizes one or more advanced/robust data encryption protocols, and/or one or more secure data transmission channels to ensure user data privacy and confidentiality. As another example, in one embodiment, the unit 270 implements one or more user permission protocols in which the unit 270 obtains and manages user consent from each user 10 for collection and analysis of user data relating to the user 10. As yet another example, in one embodiment, the unit 270 safeguards private/sensitive user information utilizing secure data storage and one or more advanced/robust authentication protocols to protect user data integrity.

In one embodiment, the system 200 comprises a user feedback unit 280. For each user 10, the unit 280 is configured to collect user feedback from the user 10 on recommendations presented to the user 10. The unit 280 enables users 10 to provide detailed and explicit input on the accuracy, relevance, and quality of recommendations presented to them.

In one embodiment, user feedback (e.g., collected via the user feedback unit 280) is forwarded to the recommendation engine 250, creating a feedback loop and a personalized feedback mechanism in which the engine 250 incorporates/integrates the user feedback to continuously improve accuracy, relevance, and quality of future recommendations. For example, if a user 10 indicates that a particular professional match recommendation is good or bad (i.e., a good or bad professional match), this user-provided input is used to refine the one or more machine learning models 252. Therefore, the system 200 is able to determine, based on user feedback, historical/past success metrics/rates that are indicative of whether past recommendations were successful professional matches. The system 200 leverages user feedback to continuously fine-tune/refine the matchmaking algorithm 251 and in turn improve the overall professional networking experience of users 10.

The system 200 integrates, via the feedback loop, a novel adaptive and continuous learning framework that continuously adapts and refines the matchmaking algorithm 251 based on user feedback, historical/past success metrics/rates, and/or industry or professional trends. This iterative process ensures that the system 200 remains attuned to an ever-evolving industry or professional domain (i.e., professional community or professional landscape) to be able to provide users 10 with accurate and up-to-date recommendations for potential successful collaborations and networking opportunities over time. Therefore, the system 200, via the matchmaking algorithm 251, implements advanced data analytics that uses predictive analytics to consider historical data (e.g., historical/past success metrics/rates) and predict future trend projections (e.g., emerging industry or professional trends). By analyzing data from past events, the AI-driven matchmaking algorithm 251 can predict attendee behavior and preferences, optimize event logistics, and assist in making data-driven decisions.

In one embodiment, the user feedback unit 280 is configured to receive, from each user 10, one or more ratings and/or reviews for an event (e.g., a conference, a trade show, a workshop, a seminar, etc.) that the user 10 was present at, a speaker at the event that the user 10 listened to, another user 10 that the user 10 engaged or interacted with, or a product or service at the event the user 10 purchased. If a user-submitted rating or review is positive, the positive rating or review may be shared on social media (e.g., posted on a social media account associated with the event/speaker/other user 10/product or service). The positive rating or review may also be included as an endorsement and/or testimonial on an event profile for the event or a user profile for the speaker, the other user 10 or an exhibitor offering the product or service. Further, the recommendation engine 250 may recommend the event/speaker/other user 10/product or service to one or more professional connections of a user 10 who submitted the positive rating or review.

In one embodiment, the user feedback unit 280 is configured to receive, from each user 10, one or more suggestions for future events. A user 10 who submits a suggestion for a future event may receive an acknowledgement from the user feedback unit 280, such as a confirmation message and/or a message of thanks.

In one embodiment, the system 200 comprises a notification unit 290 that provides proactive professional networking assistance to each user 10. For each user 10, the unit 290 is configured to generate, based on one or more professional networking preferences and a geographical location of the user 10, one or more alerts or notifications (e.g., push or pull notifications) that alert or notify the user 10 of one or more relevant professional networking events, one or more industry or professional seminars, and/or one or more industry or professional gatherings.

In one embodiment, the notification unit 290 is configured to suggest or recommend one or more professional networking actions and/or one or more professional networking opportunities a user 10 can engage in based on the user's 10 user behaviors and industry-specific or profession-specific best practices in an industry or professional domain relevant to the user 10, thereby encouraging proactive professional networking engagement and collaboration.

In one embodiment, the notification unit 290 is configured to provide a user 10 participating at, or onsite at, an event with real-time updates and notifications about the event, such as event details, event schedules, and any changes or additions to the event.

In one embodiment, if a user 10 shares content, such as an event experience (e.g., at an professional networking event), on social media (e.g., via a client-side professional networking application 120 or another application 116), the system 200 is configured to provide the user 10 with metrics indicative of other users' 10 engagement with the shared content, as well as notifications of other users' 10 interactions with the shared content (e.g., via the notification unit 290).

In one embodiment, the system 200 comprises a user (e.g., attendee, professional, vendor, event organizer, association, show organizer, etc.) reputation management unit 300 that allows each user 10 to build and showcase their professional reputation through one or more endorsements and/or testimonials from one or more other users 10, thereby overall enhancing the credibility and trustworthiness of user profiles and professional match recommendations (such as professional networking activities). In one embodiment, each user 10 (e.g., professional, vendor, event, association, show organizer, etc.) has a corresponding reputation/social credit score indicative of their professional reputation.

In one embodiment, the system 200 comprises a professional development tracking unit 310 configured to monitor, for each user 10, development of professional skills and/or career progression of the user 10. Based on the development of professional skills and/or career progression of the user 10, the recommendation engine 250 may generate recommendations that support the user 10 in their professional growth and advancement.

In one embodiment, the system 200 comprises a smart scheduling unit 320 configured to suggest or recommend to two or more users 10 optimal meeting times and locations for professional networking activities involving the two or more users 10 based on the availability and geographical proximity of the two or more users 10 (e.g., obtained from the users' 10 phones, computers, or calendar integration tools like Calendly). This facilitates efficient and convenient professional networking interactions between users 10.

In one embodiment, the system 200 comprises a virtual event integration unit 330 configured to allow users 10 to participate in virtual professional networking activities and events (e.g., webinars) seamlessly, thereby expanding professional networking opportunities of the users 10 beyond physical boundaries and geographical limitations. The smart scheduling unit 320 and the virtual event integration unit 330 each provide users 10 with a seamless professional networking experience.

In one embodiment, the system 200 comprises an advanced data analytics unit 340 configured to aggregate professional networking data from multiple users 10, and generate industry-specific or profession-specific insights and trends in an industry or profession relevant to the users 10. The industry-specific or profession-specific insights and trends are presented to the multiple users 10 (e.g., via a GUI generated by the user interface unit 260 and displayed within an application 120), thereby empowering the users 10 with valuable market intelligence and networking strategies.

Assume an example application scenario in which a user 10 attends an event and utilizes a client-side professional networking application 120 on their electronic device 110. When the user 10 arrives at the event and checks-in (e.g., by scanning a QR code on a badge or displayed within the application 120), the application 120 will initiate a scan for other attendees at the same event that are potential professional matches for the user 10. The scan may be initiated automatically to issue event badges even before the event begins or officially registering manually by automatically pairing the user's location relative to a geofenced event registration area and pairing this real-time data with the user's event registration status. Initiating the scan triggers an automatic badge issuance and starts the matchmaking algorithm 251 (on the server-side professional networking system 200) to find potential professional matches for the user 10.

In one embodiment, to find potential professional matches for the user 10, the matchmaking algorithm 251 matches a query of the user 10 who checked-in, and turns it into a vector (e.g., a numerical and/or visual vector dataset) that summarizes characteristics of a user profile for the user 10. Using vectors, the matchmaking algorithm 251 calculates similarity scores between the user profile for the user 10 and indexed user profiles for other users 10 attending at the same event. In one embodiment, various user preferences (e.g., professional background, industry, company name, job position/title, location, primary networking or career goal or objective, start deal timing, go to market timing, ideal deal size, deals per year, etc.) are weighted when determining similarity scores for matchmaking. The recommendation engine 250 ranks potential professional matches based on the similarity scores calculated, and recommends the resulting ranked potential professional matches for the user 10, which are presented to the user 10 via the application 120 as potential professional networking connections that the user 10 can make at the event.

In one embodiment, the matchmaking algorithm 251 also calculates similarity scores between the user profile for the user 10 and indexed user profiles for one or more other users 10 who are not at the event but attended past events that are similar. Any other user 10 with a high similarity score may be stored as a potential professional match for the user 10 to professionally network with when both attend another event in the future or are within proximity of each other (e.g., the user 10 may be alerted and notified, via the application 120, of this potential professional match who the user missed at the event but can professionally network with now as both are within proximity of each other).

If the recommendation engine 250 suggests a potential professional match for the user 10 (e.g., the top ranked potential professional match), the application 120 presents the user 10 with a professional match recommendation including the match and is prompted to schedule a meeting with another user 10 who is the match. If the meeting is scheduled between the user 10 and the another user 10, both users 10 receive, via their respective client-side professional networking applications 120, a confirmation message and a reminder message for the meeting.

If the recommendation engine 250 instead does not suggest a potential professional match for the user 10 (i.e., no suitable professional match is available), the user 10 may provide, via the application 120, user feedback to refine the matchmaking algorithm 251. If user feedback is provided, the user 10 receives, via the application 120, a message of thanks and a suggestion for alternative professional networking options.

As another example, in one embodiment, the user 10 utilizes the application 120 to exchange contact information and digital business cards with other attendees at the event. If contact information is exchanged, the application 120 updates a contact list of the user 10, and sends a follow-up message.

As another example, in one embodiment, the user 10 utilizes the application 120 via an AI agent to facilitate, suggest, and schedule one-on-one meetings and follow-ups with potential professional connections that the recommendation engine 250 suggests (utilizing the matchmaking algorithm 251) and the application 120 presents to the user 10. If a meeting between the user 10 and a potential professional connection is confirmed, the user 10 receives a map indicative of a location of the meeting (i.e., meeting point), as well as directions to the location.

As another example, in one embodiment, the user 10 utilizes the application 120 to access and join collaborative discussions and idea exchanges in one or more forums hosted by the server-side professional networking system 200. If the user 10 shares an idea which is acknowledged by one or more other users 10, the application 120 allows the user 10 to receive recognition for the shared idea and view the one or more other users' 10 engagement with the shared idea. This recognition may impact (e.g., improve) the user's 10 reputation/social credit score.

Table 1 below provides an example sequence of different user interactions that a user 10 can make within the client-side professional networking application 120 (“the App”) when the user 10 is onsite at an event.

```
TABLE 1
---> [Start: User Launches the App at the Event]
---> [Access Event Information and Schedule]
  ---> [View Event Agenda and Speaker Profiles with Detailed Session
  Information and Topics]
  ---> [Navigate Through Venue Map and Amenities, Including Nearby
  Networking Areas]
  ---> [Check in for Sessions and Workshops, Providing Real-Time Attendance
  Updates]
---> [Engage in Live Event Activities]
  ---> [Participate in Live Q&A Sessions and Polls, Contributing to Real-Time
  Audience Interaction Data]
  ---> [Join Networking Sessions and Group Chats, Engaging with Other
  Participants in Topic-Specific Discussions]
  ---> [Access Exclusive Event Content and Materials, Including Downloadable
  Session Resources and Reference Materials]
---> [Personalized Event Recommendations]
  ---> [Receive Tailored Session Recommendations based on Attendee Profile and
  Event Interactions]
  ---> [Get Real-Time Updates and Reminders for Upcoming Sessions and
  Networking Opportunities]
  ---> [Explore Relevant Networking Opportunities using Matchmaking
  Algorithm]
---> [Connect with Other Attendees]
  ---> [Access Matchmaking Algorithm for Networking, Utilizing Yes/No
  Functionality to Identify Suitable Matches based on Attendee Profiles and
  Preferences]
  ---> [Receive Yes Suggestions for Potential Matches, Analyzing Attendee
  Profiles and Behavioral Data]
    ---> [If Yes, Schedule One-on-One Meeting and Exchange Contact
    Information]
  ---> [Receive No Suggestions for Potential Matches]
    ---> [If No, Provide Feedback to Refine Matchmaking Algorithm]
  ---> [Exchange Contact Information and Digital Business Cards, Enabling
  Seamless Information Sharing for Future Networking and Collaborations]
    ---> [If Contact Info Exchanged, Add Contact to Personal Network and
    Send Follow-Up Message]
  ---> [Schedule One-on-One Meetings and Follow-ups, Facilitating Direct
  Communication and Professional Relationship Building]
    ---> [If Meeting Scheduled, Receive Automated Reminder and Location
    Information]
  ---> [Join Collaborative Discussions and Idea Exchanges, Participating in Topic-
  Specific Forums and Idea Sharing Sessions]
    ---> [If Idea Shared, Receive Acknowledgment and Engagement from
    Other Participants]
---> [Provide Feedback and Reviews]
  ---> [Rate and Review Sessions and Speakers, Allowing Users to Provide
  Detailed Feedback on Session Relevance and Speaker Performance]
    ---> [If Positive Review, Share Feedback on Social Media and
    Recommend Session to Connections]
  ---> [Share Event Experience on Social Media, Enabling Direct Sharing of Event
  Highlights and Key Takeaways with Personal and Professional Networks]
    ---> [If Shared, Receive Engagement Metrics and Interaction
    Notifications]
  ---> [Submit Suggestions for Future Events, Allowing Users to Contribute Ideas
  for Event Improvement and Content Enhancement]
    ---> [If Suggestion Submitted, Receive Confirmation and Thank You
    Message]
---> [End: User Exits the App]
```

Table 2 below provides example pseudocode implementing the system 200, in one embodiment.

```
TABLE 2
import numpy as np
from sklearn.feature_extraction.text import TfidfVectorizer
from sklearn.metrics.pairwise import cosine_similarity
from sklearn.preprocessing import StandardScaler
import pandas as pd
from nltk.corpus import stopwords
from nltk.stem import WordNetLemmatizer
import re
# Example data (to be replaced with actual data collection methods)
professionals = [
{“name”: “Alice”, “job_title”: “Senior Software Engineer”, “work_experience”: “10
years”,
“keywords”: “Software, Engineering, Python”, “events”: [“Tech Conference 2023”],
“organizations”: [“IEEE”]},
# ... add more profiles
]
# Data Cleansing
def clean_text(text):
  # Remove special characters and numbers
  text = re.sub(r‘[\hat{ }a-zA-Z\s]’, ”, text, re.I|re.A)
  # Tokenize text
  text = text.lower( )
  tokens = text.split( )
  # Remove stopwords
  tokens = [token for token in tokens if token not in stopwords.words(‘english’)]
  # Lemmatize
  lemmatizer = WordNetLemmatizer( )
  tokens = [lemmatizer.lemmatize(token) for token in tokens]
  return ‘ ’.join(tokens)
for professional in professionals:
  professional[‘job_title’] = clean_text(professional[‘job_title’])
  professional[‘keywords'] = clean_text(professional[‘keywords'])
# Feature Extraction
vectorizer = TfidfVectorizer( )
job_titles_matrix = vectorizer.fit_transform([p[‘job_title’] for p in professionals])
keywords_matrix = vectorizer.fit_transform([p[‘keywords'] for p in professionals])
# Profile Indexing
# Here you would use a more sophisticated method to create a searchable index. For
simplicity, we're just using the matrices created above.
# Matchmaking algorithm
def check_in_and_match(new_profile, event_name):
  # Clean and vectorize new profile data
  new_profile_vector = vectorizer.transform([new_profile[‘job_title’] + “ ” +
new_profile[‘keywords']])
  # Calculate similarity with existing profiles
  similarities = cosine_similarity(new_profile_vector, job_titles_matrix)
  # Find profiles that are attending the same event
  event_profiles = [p for p in professionals if event_name in p[‘events']]
  event_profiles_vectors = vectorizer.transform([p[‘job_title’] + “ ” + p[‘keywords']
  for p in event_profiles])
  # Calculate similarity scores for the event
  event_similarities = cosine_similarity(new_profile_vector,
  event_profiles_vectors)
  # Rank and return the top matches
  top_matches_indices = np.argsort(event_similarities[0])[::−1]
  top_matches = [event_profiles[i] for i in top_matches_indices]
  return top_matches
# Result Refinement
# This function would include more sophisticated logic based on user preferences and
location.
# Feedback Loop
# This would be a more complex system involving machine learning models. For now,
we'll just
assume there's a function that retrains our model based on feedback.
def retrain_model_on_feedback(feedback_data):
  # Machine learning retraining logic goes here
  pass
# Example usage
new_profile = {
  “name”: “Bob”,
  “job_title”: “Software Developer”,
  “work_experience”: “5 years”,
  “keywords”: “Developer, Python, JavaScript”,
  “events”: [“Tech Conference 2023”],
  “organizations”: [“ACM”]
}
# The person checks in at the event
event_name = “Tech Conference 2023”
matches = check_in_and_match(new_profile, event_name)
print(“Top matches for new check-in:”, matches)
```

Table 3 below provides example high-level pseudocode implementing the system 200, in one embodiment.

```
TABLE 3
Function (user):
  // Step 1: Collect and analyze user profile data
  demographic_data = GetUserDemographicData(user)
  preference_data = GetUserPreferenceData(user)
  // Step 2: Collect and analyze in-app behavioral data
  in_app_behavior_data = GetInAppBehaviorData(user)
  // Step 3: Collect and analyze external online behavioral data
  external_behavior_data = GetExternalBehaviorData(user)
  // Step 4: Collect and analyze location data
  location_data = GetUserLocationData(user)
  // Step 5: Process real-time news to identify relevant topics and events
  relevant_news_data = ProcessRealTimeNews( )
  // Step 6: Dynamic questioning to gather additional insights
  dynamic_question_data = GetDynamicQuestionData(user)
  // Step 7: Combine all collected data into a comprehensive user profile
  comprehensive_profile = CombineData(
  demographic_data,
  preference_data,
  in_app_behavior_data,
  external_behavior_data,
  location_data,
  relevant_news_data,
  dynamic_question_data
  )
  // Step 8: Utilize machine learning to find potential matches
  potential_matches =
  MachineLearningMatching(comprehensive_profile)
  // Step 9: Rank potential matches based on a scoring system
  ranked_matches = RankMatches(potential_matches)
  // Step 10: Present matches to the user
  PresentMatchesToUser(user, ranked_matches)
  // Step 11: Collect user feedback on matches
  user_feedback = CollectUserFeedback(user)
  // Step 12: Utilize user feedback to improve matchmaking algorithm
  UpdateAlgorithmWithFeedback(user_feedback)
  Return
```

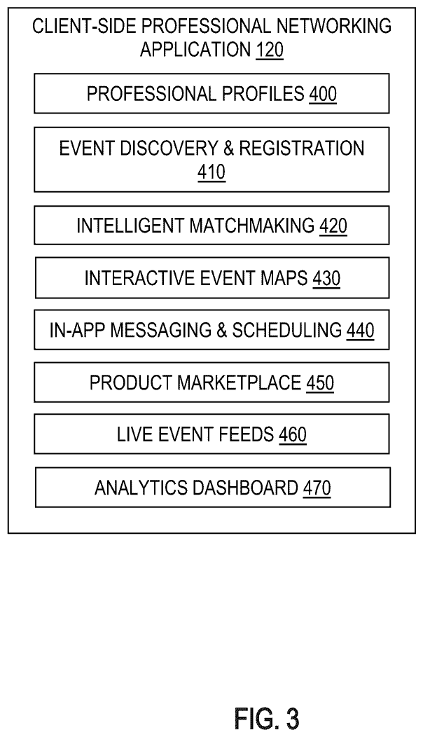

FIG. 3 illustrates an example client-side professional networking application 120, in one or more embodiments. The application 120 provides a user 10 with multiple features/functionalities, as described herein below.

In one embodiment, the application 120 includes a professional profiles unit 400 configured to allow the user 10 to create and customize their own professional user profile showcasing the user's 10 business, products, or services. The application 120 sends user-provided data that the user 10 inputs while creating/customizing their own professional user profile to the server-side professional networking system 200 where the data is collected and used to create a corresponding user profile for the user 10 (e.g., via the data collection system 210 and the user profiling unit 220). The user 10 can access, view, and update their professional user profile within the application 120 via a user profile dashboard generated by the unit 400.

The professional profiles unit 400 facilitates profile customization by allowing the user 10 to upload a professional user profile and one or more cover photos. The professional user profile and/or cover photos may be uploaded from the user's 10 electronic device 110 or another website, such as LinkedIn®.

The professional profiles unit 400 allows the user 10 to supplement or augment their professional user profile with a portfolio showcasing their work, products, services, or projects. The user 10 may upload images, videos, and documents to their portfolio. Their portfolio may also include endorsements and/or testimonials from clients, colleagues, and other users 10 the user 10 has engaged and interacted with, relative to their reputation/social credit score.

The professional profiles unit 400 is configured to allow the user 10 to browse through a directory of professional user profiles for other users 10 (e.g., professionals, attendees, vendors, event organizers, show organizers, associations, etc.), enabling the user 10 to discover potential business partners, potential clients, potential suppliers, and other potential professional connections. The unit 400 allows the user 10 to search and filter the directory, enabling the user 10 to discover other users 10 based on filters such as, but not limited to, industry, location, interests, past event attendance, etc.

Table 4 below provides an example flowchart outlining a user's 10 journey through features provided within the application 120 by the professional profiles unit 400, in one embodiment.

TABLE 4

Start
|
|--- User Registration
| |
| |--- Provide Basic Information (Name, Email, Password)
| |
| |--- Profile Setup Wizard
| | |
| | |--- Upload Profile Photo
| | |--- Add Personal Description
| | |--- Link Social Media Profiles
| | |--- Define Business Role
| | |--- Set Interests and Goals
| | |--- Select Industry
| | |--- Set Event Preferences
| |
| |--- Additional Information
| | |
| | |--- Company Name
| | |--- Position/Title
| | |--- Ideal Deal Size
| | |--- Deals per Year
| |
| |--- Complete Registration
|
|--- Preferences and Settings
| |
| |--- Notification Preferences
| |
| |--- Privacy Settings
|
|--- User Profile Dashboard

In one embodiment, the application 120 includes an event discovery and registration unit 410 configured to generate and present to a user 10 a curated listing of upcoming events (“event listing”) in a relevant industry or profession. Examples of events include, but are not limited to, trade shows, seminars, sessions, panel discussions, workshops, business meetups, etc. The user 10 can browse the event listing to discover and view detailed information (e.g., event schedules, speaker line-up, exhibitor lists, venue maps, etc.) about each upcoming event of interest. The unit 410 allows the user 10 to search and filter the event listing, enabling them to discover upcoming events based on filters such as, but not limited to, industry, location, date, popularity, etc.

For any upcoming event the user 10 has selected, within the application 120, to register for, the unit 410 is configured to register the user 10 for the event. For example, in one embodiment, the event discovery and registration unit 410 generates a user registration form for display within the application 120. The user registration form includes fields for collecting user data, such as personal information, event preferences, etc. The user registration form allows the user 10 to seamlessly register for an upcoming event and allow for auto-badge issuance.

In one embodiment, the event discovery and registration unit 410 offers a payment gateway, allowing secure payment processing for event registration fees and ticket purchases. Within the application 120, a user 10 registering for an upcoming event can pay event registration fees for the event and/or purchase tickets to the event.

If the user 10 is an exhibitor at an event, the event discovery and registration unit 410 facilitates the showcase of products or services offered by the user 10. If the user 10 is an attendee at an event instead, the system 210 allows the user 10 to explore the latest industry-specific or profession-specific products or services that are exhibited at the event and relevant to the user 10.

The event discovery and registration unit 410 allows users 10 to read reviews about events, as well as submit their own reviews about events they have attended, enabling other users 10 to make an informed decision.

In one embodiment, the event discovery and registration unit 410 generates an event management dashboard for display within the application 120. A user 10 who is an event organizer can access the event management dashboard within the application 120 to manage their events, view participant lists, and track registrations and attendance trends and nuanced behaviors or matches, sentiment, successes/failures, as well as advanced event analytics.

Table 5 below provides an example flowchart outlining a user's 10 journey through features provided within the application 120 by the event discovery and registration unit 410, in one embodiment.

TABLE 5

User Profile Dashboard
|
|--- Event Discovery
| |
| |--- Browse Events
| | |
| | |--- Filter by Industry, Location, Date
| | |--- View Event Previews
| | |--- Event Search
| |
| |--- Event Details
| | |
| | |--- Event Schedule
| | |--- Speakers and Exhibitors
| | |--- Venue Maps
| |
| |--- Registration
|
|--- Event Registration Confirmation

In one embodiment, the application 120 includes an intelligent matchmaking unit 420 configured to invoke the recommendation engine 250/matchmaking algorithm 251 (on the server-side professional networking system 200) to analyze the user's 10 user profile and user preferences and suggest other users 10 that are potential professional matches for the user 10. Any potential professional match suggested by the recommendation engine 250/matchmaking algorithm 251 is presented to the user 10 via the application 120. For example, if the user 10 is at an event, a potential professional match presented to the user 10 may be another professional attending the same event, an exhibitor at the event, or another attendee of the event. The intelligent matchmaking unit 420 allows the user 10 to engage in one-to-one or one-to-many matchings to maximize professional networking opportunities (e.g., facilitates scheduling of meetings or activities with potential professional matches).

The intelligent matchmaking unit 420 allows the user 10 to set their professional networking and matching preferences (e.g., based on business goals, interests, event participation, etc.), as well as opt-in or opt-out of matchmaking for specific events.

The intelligent matchmaking unit 420 is configured to provide the user 10 with a real-time or periodic (e.g., daily, weekly, etc.) listing of potential matches based on user preferences and user interactions of the user 10. When reviewing a professional profile of a potential match via the application 120, the user 10 may perform certain gestures, such as swipe right/up to accept the match or swipe left/down to dismiss/pass on the match.

Table 6 below provides an example flowchart outlining a user's 10 journey through features provided within the application 120 by the intelligent matchmaking unit 420, in one embodiment.

TABLE 6

User Profile Dashboard
|
|--- Intelligent Matchmaking
||
||--- Profile Analysis
|||
|||--- Analyze User Profile
|||--- Set Matching Preferences
||
||-- Match Suggestions
|||
|||--- One-to-One Matching
||||
||||--- Swipe Right (Interested)
||||--- Swipe Left (Not Interested)
|||
|||--- One-to-Many Matching
|
|--- Matchmaking Results

In one embodiment, the application 120 includes an interactive event maps unit 430 configured to generate interactive and live event maps for events. When the user 10 is at an event, the unit 430 generates a corresponding interactive and live event map which is displayed to the user 10 via the application 120. The event map allows the user 10 to find and navigate through the venue the event is held at with ease. For example, with the event map, the user 10 may locate exhibitor booths, stages, seminar halls, professional networking zones, potential matches, and meeting points (e.g., with potential matches) quickly. The event map may include directions, directional arrows, augmented reality (AR) visuals, markers, and other navigation aids to direct the user 10 to a location or person of interest.

The interactive event maps unit 430 allows a user 10 to share their own real-time location at events with potential matches to facilitate meetups during the events. For example, the user's 10 real-time location at an event will be visible on an interactive and live event map for the event that is displayed to a potential match for the user 10.

The interactive event maps unit 430 allows a user 10 to reserve one or more booth spaces at an event in advance or on the go, as well as manage each booth reservation, all via the application 120.

Table 7 below provides an example flowchart outlining a user's 10 journey through features provided within the application 120 by the interactive event maps unit 430, in one embodiment.

TABLE 7

User Profile Dashboard
|
|--- Interactive Event Maps
||
||--- Real-time Location Sharing
|||
|||--- Share Location with Connections
|||--- Locate Booths and Meeting Points
||
||-- Booth Reservations
|||
|||--- Reserve Booth Spaces
|||--- View and Manage Reservations

In one embodiment, the application 120 includes an in-app messaging and scheduling unit 440 configured to allow a user 10 to connect, via the application 120, with one or more potential matches through encrypted in-app messaging. The user 10 can initiate, or continue, a discussion of business or networking opportunities with a potential match without having to meet face-to-face. Via the in-app messaging, users 10 can securely chat with professional connections, securely send images, videos, and documents to professional connections, securely share contact details with professional connections, and create group chats for specific events or topics.

The in-app messaging and scheduling unit 440 allows a user 10 to schedule, via an AI agent in the application 120, meetings, seminars, casual meetups, and other professional networking activities. In one embodiment, the unit 440 triggers the smart scheduling unit 320 (on the server-side professional networking system 200) to suggest optimal meeting times and locations for professional networking activities that the user 10 wants to schedule. The unit 440 allows a user 10 to propose, accept, reschedule, or cancel meetings or other professional networking activities with professional connections, all via the application 120. The unit 440 can sync scheduled meetings and other professional networking activities with a user's 10 personal or work calendar. The application 120 offers seamless cross-platform integration with other professional and business tools, allowing data, schedules, and contacts to sync across platforms effortlessly.

Table 8 below provides an example flowchart outlining a user's 10 journey through features provided within the application 120 by the in-app messaging and scheduling unit 440, in one embodiment.

TABLE 8

User Profile Dashboard
|
|--- In-app Messaging and Scheduling
||
||--- Messaging
|||
|||--- Chat with Connections
|||--- Share Images and Documents
|||--- Create Group Chats
||
||--- Meeting Scheduler
|||
|||--- Propose, Accept, Reschedule Meetings
|||--- Sync Meetings with Calendar

In one embodiment, the application 120 includes a product marketplace unit 450 configured to allow a user 10 to explore a virtual marketplace associated with an event, where exhibitors/sellers/vendors can list products and/or services, and attendees can browse and make purchases. The user 10 can provide, via the application 120, ratings and reviews, and engage in one or more Q&As to foster a community of informed buyers and sellers. In one embodiment, the user feedback unit 280 (on the server-side professional networking system 200) collects the user-provided rating and reviews from the application 120.

In one embodiment, the product marketplace unit 450 generates product and/or service listings for inclusion in the virtual marketplace. Specifically, the unit 450 allows an exhibitor/seller/vendor to list, manage, and promote their products and/or services via the application 120. The unit 450 provides an exhibitor/seller/vendor with the option of featuring their product and/or service listing in the virtual marketplace, thereby enhancing the visibility of the exhibitors' products and/or services.

When a user 10 makes a purchase order for a product or service listed in the virtual marketplace via the application 120, the product marketplace unit 450 can manage the purchase order, process an in-app payment from the user 10 for the purchase order, and update in-app the status of the purchase order. The unit 450 also allows exhibitors/sellers/vendors to communicate, via the application 120, with buyers for inquiries related to purchase orders for their products and/or services.

Table 9 below provides an example flowchart outlining a user's 10 journey through features provided within the application 120 by the product marketplace unit 450, in one embodiment.

TABLE 9

User Profile Dashboard
|
|--- Product Marketplace
||
||--- Product Listings
|||
|||--- List, Manage, and Promote Products
|||--- Manage Orders and Payments
|||--- Product Reviews and Q&A

In one embodiment, the application 120 includes a live event feeds unit 460 configured to provide a user 10 with one or more live event feeds associated with an event, enabling the user 10 to stay up to date on the latest announcements, ongoing sessions, presentations, and panel discussions at the event, and trending discussions. The unit 460 enables session livestreaming, such that users 10 can watch live or recorded sessions, presentations, and panel discussions at the event via the application 120. In one embodiment, an AI agent can notify users 10 with high intent notifications from live events feeds for the events and sessions they are participating in or registered for.

To engage with a professional networking community, the live event feeds unit 460 allows a user 10 to share and view insights, photos, videos, and/or updates from events in real-time via the application 120. In one embodiment, users 10 can engage with content shared by their professional connection through likes, comments, and re-sharing.

Table 10 below provides an example flowchart outlining a user's 10 journey through features provided within the application 120 by the live events feed unit 460, in one embodiment.

TABLE 10

User Profile Dashboard
|
|--- Live Event Feeds
||
||--- Event Highlights
|||
|||--- Share Photos, Videos, Updates
|||--- Engage with Posts
||
||--- Session Livestreaming
|||
|||--- Watch Live or Recorded Sessions
|||--- Participate in Q&A and Discussions

In one embodiment, the application 120 includes an analytics dashboard unit 470 configured to track a user's 10 engagement and interactions at an event, and provide the user 10 and/or an event or show organizer with real-time analytics and feedback that the user 10 and/or the event or show organizer can use to gauge professional networking success at the event. For example, the real-time analytics and feedback may include engagement metrics that measure return on investment from the user's 10 event participation, and insights into the user's 10 professional networking performance at the event. The user 10 and/or the event or show organizer can access and view the real-time analytics and feedback within the application 120 via an analytics dashboard generated by the unit 470. The engagement metrics include, but are not limited to, visits from other users 10 to the user's 10 professional user profile, requests from other users 10 to professionally connect, messages from other users 10 to the user 10 (i.e., messaging activity), traffic to the user's 10 booth, interaction metrics during the events, etc. Based on feedback from event attendees and professional connections (e.g., collected via the user feedback unit 280), the unit 470 analyzes the feedback to suggest, via the application 120, how the user 10 and/or the event or show organizer can improve future event participation and business strategies.

Table 11 below provides an example flowchart outlining a user's 10 journey through features provided within the application 120 by the analytics dashboard unit 470, in one embodiment.

TABLE 11

User Profile Dashboard
|
|--- Analytics Dashboard
||
||--- Track Engagement Metrics
|||
|||--- Profile Visits, Connection Requests
|||--- Evaluate Booth Traffic
||
||--- Feedback Collection
|||
|||--- Collect and Analyze Feedback
|||--- Improve Future Event Participation

Table 12 below describes some example additional features/functionalities the application 120 provides, in one embodiment.

TABLE 12

| Feature/Functionality | | |
|---|---|---|
| Category | Feature/Functionality | Description |
| Virtual Business | Digital Business | Users can create and share digital |
| | Cards | business cards with QR codes. Users |
| | | can scan others' QR codes to |
| | | instantly save their contact details. |
| Card Exchange | Card Management | Users can organize, search, and |
| | | categorize digital business cards they |
| | | have collected. Users can export |
| | | contact details to their electronic |
| | | devices 110 (e.g., mobile phone) or a |
| | | customer relationship management |
| | | (CRM) system. |
| Gamification | Networking | Users can participate in professional |
| | Challenges | networking challenges to meet new |
| | | professional connections and earn |
| | | rewards. |
| | Leaderboards | Users can climb in-app leaderboards |
| | | by engaging with the application |
| | | more, attending events, and |
| | | expanding their professional network. |
| Sponsorship | Sponsor Listings | The application can showcase |
| | | sponsors and partners for each event. |
| | | The application can offer sponsored |
| | | posts, banners, and booth highlights |
| | | to increase visibility for sponsors. |
| Industry News and | News Feed | Users can subscribe to a curated news |
| | | feed to stay updated with the latest |
| | | industry news, articles, and insights |
| | | tailored to their interests. |
| Insights | Discussion Forums | Users can participate in discussion |
| | | forms to engage in discussions on |
| | | trending topics and share their |
| | | expertise. |
| Membership Levels | Subscription Plans | The application offers various |
| | | subscription plans, such as free and |
| | | premium membership plans for |
| | | enhanced features and benefits. |
| | Corporate Packages | The application offers corporate |
| | | packages to businesses to manage |
| | | multiple users and receive group |
| | | discounts. |
| Integration with | CRM Integration | Users can sync their contacts, |
| | | meetings, and interactions with their |
| | | CRM systems. |
| External Tools | Social Media | Users can share their activities on the |
| | Integration | application to their social media |
| | | accounts with ease. |
| Learning Hub | Courses | Users can access a library of online |
| | | courses tailored to their industry or |
| | | profession. Users can engage in live |
| | | training sessions or on-demand |
| | | tutorials to enhance their professional |
| | | skills. |
| | Certifications | Users can earn certifications to |
| | | showcase their proficiency in specific |
| | | areas. Users can track and share their |
| | | learning milestones within the |
| | | application. |
| On-Demand Video | Industry Talks | Users can watch recorded talks, panel |
| Library | | discussions, and webinars from past |
| | | events. Users can engage with |
| | | interactive Q&A sessions and |
| | | discussion threads. |
| | Product Demos | Users can discover new products and |
| | | services through video demos. Users |
| | | can connect with exhibitors and |
| | | suppliers for more information on the |
| | | products and services. |
| Group Networking | Interest Groups | Users can join groups based on |
| | | industry, event themes, or business |
| | | topics. Users can engage in |
| | | discussions, share insights, and |
| | | schedule meetups. |
| | Roundtable | Users can participate in live virtual or |
| | Discussions | in-person roundtable discussions on |
| | | pertinent topics. Users can network |
| | | with like-minded professionals and |
| | | share experiences. |
| Mentorship Program | Find a Mentor | Users can connect with experienced |
| | | professionals willing to provide |
| | | mentorship. Users can Set goals, |
| | | schedule discussions, and track their |
| | | progress. |
| | Become a Mentor | Users can offer mentorship to others, |
| | | share their expertise, and build |
| | | meaningful relationships. |
| Job Board | Job Listings | Users can browse job openings |
| | | relevant to their industry or |
| | | profession and expertise. Users can |
| | | apply to jobs and track their |
| | | application status within the |
| | | application. |
| | Recruitment | Users can post job openings, review |
| | | applications, and connect with |
| | | potential candidates. |
| Business Resources | Toolbox | Users can access a toolbox of |
| | | business resources, templates, and |
| | | guides. Users can receive assistance |
| | | on legal, financial, marketing, and |
| | | other business essentials. |
| | Expert Advice | Users can schedule consultations with |
| | | industry experts for personalized |
| | | advice. |
| Event Booth Live | Live Showcases | Users can watch live streams of |
| Streams | | product demos, presentations, or |
| | | Q&A sessions that exhibitors live |
| | | stream from their booths. Attendees |
| | | can tune in, interact, and schedule |
| | | follow-up discussions. |
| Event Surveys and | Feedback Collection | The application can create and |
| Polls | | distribute surveys and polls to collect |
| | | feedback from event participants. The |
| | | application can analyze responses to |
| | | improve future events and understand |
| | | attendee needs. |
| Sponsored Content | Sponsored Sessions | Businesses can sponsor sessions or |
| | | content within the application. The |
| | | application can promote sponsored |
| | | content through banners, push |
| | | notifications, and featured listings. |
| Premium Access | Exclusive Content | The application offers users premium |
| | | access passes for exclusive content, |
| | | advanced professional networking |
| | | features, and other perks. |
| Passes | VIP Event Access | The application offers users VIP |
| | | access to special event sessions, |
| | | lounges, and professional networking |
| | | opportunities. |
| Mobile Ticketing and | Event Passes | Users can manage their event passes, |
| | | tickets, and check-ins all within the |
| | | application. |
| Check-In | Contactless Check-In | Users can utilize QR codes displayed |
| | | within the application for contactless |
| | | check-in and to access different areas |
| | | within an event (i.e., badge access or |
| | | clearance). |
| Advertisement | Advertisement | Users can create and manage |
| Platform | Campaigns | advertisement campaigns to promote |
| | | their business, products, services, or |
| | | event booths. |
| | Advertising Analytics | Users can track the performance of |
| | | their advertisement campaigns to |
| | | measure ROI and optimize their |
| | | campaigns. |

Table 13 below describes some example real-time networking and location-based features/functionalities the application 120 provides, in one embodiment.

TABLE 13

| Feature/Functionality | Description |
|---|---|
| Real-Time Networking | The application provides users with real-time heatmaps |
| Heatmap and Wayfinding | showing areas of high networking activity at events, and |
| | offers the users personalized navigation through event |
| | venues to guide them to relevant sessions or professional |
| | matches. |
| Proximity-Based | The application sends users alerts when they are near a |
| Networking Alerts | relevant professional match or networking hotspot, |
| | thereby using real-time data to optimize networking |
| | opportunities. |
| AI-Powered Networking | The application analyzes traffic patterns at events, and |
| Traffic Analysis | provides data to event organizers identifying networking |
| | hotspots at the events in real-time. |
| Location-Aware Match | The application adjusts professional match |
| Suggestions | recommendations (e.g., potential professional matches) |
| | based on users' current location within an event, thereby |
| | suggesting networking opportunities based on physical |
| | proximity. |
| Real-Time Local Event | The application notifies users of nearby events or |
| Finder | networking activities while attending a conference, |
| | thereby enhancing their overall experience. |
| Interest-Based Local | The application recommends local bars, restaurants, or |
| Venue Suggestions | other attractions based on users' interests when they |
| | attend an event at a location that is new to them. |
| Provide Shared | The application offers professional matches a place to |
| Networking Locations | eat or an activity to do while networking, based on past |
| | interactions and shared interests. |
| Personalized Tourism | The application provides users with tourism suggestions |
| Recommender | related to their interests, including sports events, cultural |
| | activities, or local attractions. |
| Past Matches Connection | If a prior professional match is nearby, the application |
| | recommends users to a reach out to the match or suggest |
| | to the match a meeting. |
| Instant Suggested Matches | The application reviews the professional connections of |
| | users' professional matches, and suggests additional |
| | professional matches who are mutually known and |
| | nearby for the users to connect with. |
| Insta-Match | The application provides a filter which instantly allows |
| | users to view professional matches based on immediate |
| | wants and needs, such as a uber ride-share, golf, tennis, |
| | restaurant, dinner or other social activities which will be |
| | available to book through third party integrations like |
| | OpenTable or GolfNow, for example. The application |
| | can filter to focus on professional matches only at events |
| | as opposed to global professional matches. The |
| | application can utilize AI to suggest instant professional |
| | matches depending on users' location and activity on |
| | theirs electronic devices (e.g., mobile phones). |

Table 14 below describes some example AI-powered matching and recommendation features/functionalities the application 120 provides, in one embodiment.

TABLE 14

| Feature/Functionality | Description |
|---|---|
| AI-Generated Personalized | Creates personalized networking agendas based on past |
| Networking Agendas | interactions, event schedules, and user preferences. |
| AI-Powered Conversation | Analyzes past conversations to suggest personalized |
| History Analyzer | follow-up topics and maintain engagement. |
| AI-Driven Follow-Up | Reminds users to follow up with contacts post-event and |
| Assistant | suggests personalized follow-up messages based on |
| | interaction sentiment |
| AI-Driven Networking | Provides real-time tips and strategies for improving |
| Coaching | networking interactions during events. |
| AI-Driven Networking | Analyzes interaction patterns to predict which |
| Success Predictor | connections are most likely to lead to future |
| | collaborations. |
| AI-Generated Score | An algorithm that creates a dynamic letter grade or |
| | percentage score based on attributes and adjusts |
| | depending on location, event context, and networking |
| | goals. |
| Use of AI Agents for | Utilizes AI to handle booking or securing reservations, |
| Booking | tee times, or other activities for two parties by accessing |
| | their calendar availability and confirming with each user. |
| Connection Suggestions | Suggests potential matches based on users' networking |
| | graphs, analyzing connection trends and behavioral |
| | patterns. |
| AI Chat Analysis | Looks at chats between individuals and makes |
| | suggestions for activities, attractions or topics based on |
| | conversation between the individuals. One click booking |
| | for activities based on shared calendars. |

Table 15 below describes some example personalization and user experience features/functionalities the application 120 provides, in one embodiment.

TABLE 15

| Feature/Functionality | Description |
|---|---|
| Matchmaking Profile | Enables users to dynamically customize their |
| Customizer | matchmaking profile based on event sessions or evolving |
| | interests. |
| Personalized Networking | Generates a plan after an event for maintaining |
| Action Plan | connections and leveraging networking results based on |
| | interactions and user feedback. |
| Dynamic Meeting | Automatically adjusts meeting times based on real-time |
| Scheduler | availability and schedule changes by scanning integrated |
| | calendars. |
| Event-Based Conversation | Suggests conversation starters based on event sessions or |
| Starters | personal interests to enhance networking interactions. |
| Event Match Notifications | Alerts users when new potential matches attend an event |
| | or become available for networking. |
| Smart Event Agenda | Integrates the event agenda with personal calendars to |
| Integration | suggest optimal networking windows and avoid |
| | scheduling conflicts, through third party integrations into |
| | the user's calendar via Calendy, for example. |
| Personalized Activity | Automatically suggests and books activities (e.g., dinner, |
| Booking Assistant | sports) for matched attendees to enhance networking |
| | experiences. |
| Context-Aware | Suggests icebreakers based on attendee profiles and |
| Icebreaker Suggestions | current event session topics to facilitate engaging |
| | conversations. |

Table 16 below describes some example performance evaluation and feedback features/functionalities the application 120 provides, in one embodiment.

TABLE 16

| Feature/Functionality | Description |
|---|---|
| Event-Based Match | Allows users to rate their networking interactions and |
| Rating System | provides insights for future matchmaking improvements. |
| Feedback Mechanism for | Enables users to provide feedback on the quality of their |
| Matches | matches and interaction outcomes, influencing future |
| | matchmaking algorithms. |
| Networking Efficiency | Evaluates how efficiently attendees use their networking |
| Scoring | time at an event and provides feedback for improvement. |
| Networking Interaction | Monitors the quality of networking interactions and |
| Quality Tracker | provides personalized insights and suggestions for |
| | enhancement. |
| Peer Feedback Tool | Allows users to give and receive feedback on their |
| | networking performance from peers, helping refine |
| | networking strategies. |
| Networking Skill | Evaluates users' networking skills and provides a |
| Assessment | customized improvement plan based on feedback and |
| | peer input. |
| Automatic Background | Looks at how people interact with matches. Did they |
| | Feedback |
| | engage in a lengthy conversation over chat and meet in |
| | person. Use sentiment analysis and review of chat. Use |
| | this feedback to enhance matches in the future. |

Table 17 below describes some example security and privacy features/functionalities the application 120 provides, in one embodiment.

TABLE 17

| Feature/Functionality | Description |
|---|---|
| Advanced Security and | A suite of security tools for users to block certain |
| Privacy Controls | individuals, become invisible at events, or customize |
| | visibility to manage their privacy and networking |
| | exposure. |
| Automated Contact | Uses near-field communication for instant exchange of |
| Exchange via NFC | contact information between attendees, providing a secure |
| | and convenient way to share details. |

Table 18 below describes some example engagement and gamification features/functionalities the application 120 provides, in one embodiment.

TABLE 18

| Feature/Functionality | Description |
|---|---|
| Networking Goals | Allows users to set specific networking goals and |
| Tracker | provides real-time feedback, notifications, and tips to help |
| | achieve these goals during an event. |
| Event-Linked Goal Setting | Allows users to set and monitor networking goals tied to |
| and Tracking | specific event sessions, with real-time updates and |
| | tracking. |
| Real-Time Achievement | Gamifies networking by awarding badges for achieving |
| Badges | specific goals (e.g., number of matches, successful |
| | meetings). |
| Handshake or Connect | Enables users to express interest in connecting by clicking |
| Button | a “handshake” or “fist bump” button when viewing a |
| | profile, facilitating quick and intuitive engagement. |

Table 19 below describes some example third-party integrations and tourism revenue enhancement features/functionalities the application 120 provides, in one embodiment.

TABLE 19

| Feature/Functionality | Description |
|---|---|
| Integration for Enhanced | The application integrates with third-party services such |
| Local Experiences | as OpenTable, Ticketmaster, and local Convention and |
| | Visitors Bureaus (CVBs) to provide real-time |
| | recommendations and booking options for networking |
| | activities with professional connections, such as dining |
| | reservations, local attractions, sporting events, and |
| | sightseeing tours based on user interests and schedules. |
| Open API for Networking | The application connects to all types of third-party |
| | booking applications via open APIs to allow other tools to |
| | leverage connections made on the application. |
| Dynamic Tourism | The application provides an AI-driven engine that uses |
| Connection Engine | integrated data from local CVBs to generate personalized |
| | recommendations for event attendees, optimizing the |
| | event's economic impact on the local area and driving |
| | tourism revenue. |
| Integration for Seamless | The application integrates with online restaurant- |
| Dining Reservations | reservation services, such as OpenTable, to enable |
| | automatic and seamless dining reservations for event |
| | attendees and matched professional connections, allowing |
| | users to book lunch or dinner meetings directly through |
| | the application. |
| Integration for Sporting | The application integrates with online ticket sales |
| Events and Entertainment | services, such as Ticketmaster, to suggest and book |
| | tickets for nearby concerts, sporting events, and |
| | entertainment options, allowing attendees to plan leisure |
| | networking activities with professional connections in |
| | conjunction with networking schedules, through third |
| | party integrations to reservation systems like StubHub, |
| | for example. |
| Golf Course and Sports | The application integrates with local golf courses, sports |
| Activity Reservations | clubs, and adventure parks to facilitate activity bookings |
| | with matched professional connections, providing a |
| | unique way for users to interact outside of an event, |
| | through third party integrations to reservation systems |
| | like GolfNow, for example. |
| AI-Driven Itinerary | The application collaborates with local CVBs to create |
| Creation with Local CVBs | AI-driven personalized itineraries for attendees, |
| | incorporating guided tours, cultural experiences, and |
| | exclusive event-based local offerings. |
| Partnership with Airlines | The application has strategic partnerships with airlines, |
| and Airport Facilities | airport lounges, and restaurants to provide enhanced |
| | services to event attendees during their travel, including |
| | express check-in, meal reservations, and priority lounge |
| | access, all integrated directly within the application. |
| Exclusive Airport Lounge | The application allows high-priority professional matches |
| Access for High-Priority | or VIP attendees to receive complimentary or prioritized |
| Matches | access to airport lounges, enhancing their travel and |
| | networking experience. |
| Airport Restaurant | The application integrates with airport restaurants to |
| Integration for Meet-and- | facilitate meet-and-greet sessions between attendees |
| Greet Opportunities | before or after the event, enabling them to make the most |
| | of their travel time. |
| Tourism and Local | The application implements comprehensive revenue |
| Business Revenue | optimization to measure and analyze the impact of |
| Optimization | attendee spending on local businesses, using integrated |
| | tourism and hospitality data to generate insights for local |
| | municipalities on maximizing economic gains. |
| Custom AI-Based | The application automatically generates |
| Itinerary for Sightseeing | custom/personalized AI-powered itineraries for |
| and Tourism | sightseeing, cultural activities, and special events based |
| | on user preferences and available time slots during their |
| | stay, making it easier to explore local attractions. |
| Dynamic Meeting and | The application offset a scheduler tool that coordinates |
| Leisure Activity Scheduler | professional meetings with leisure activities (e.g., golf, |
| | wine tastings, city tours) based on user interests, |
| | optimizing networking opportunities while promoting |
| | local tourism and hospitality offerings. |
| Enhanced Networking | The application leverages exclusive partnerships with |
| Through Exclusive Local | local restaurants, bars, and clubs to offer unique discounts |
| Partnerships | and private event options, incentivizing users to engage |
| | with the local community. |
| Real-Time Notifications | The application sends real-time notifications to attendees |
| for Local Offers and | about exclusive local offers, events, and experiences as |
| Events | they move through the event location, driving additional |
| | engagement and promoting local services. |
| Tourism Revenue | The application offers an advanced data analytics feature |
| Tracking and Reporting | that tracks attendee engagement with local businesses and |
| | generates detailed tourism revenue reports for event |
| | organizers and local municipalities, providing actionable |
| | insights for future event planning and partnership |
| | strategies. |

The application's 120 various unique integrations with third-party platforms and strategic partnerships, as shown in Table 19, enhance both user experience and local economic impact. By seamlessly connecting attendees to local services, attractions, and exclusive offerings, the application 120 transforms the event experience into a comprehensive business and tourism opportunity.

Table 20 below describes some example features/functionalities the application 120 provides to event organizers, in one embodiment. An event organizer may access some of the features/functionalities described in Table 20 via the event management dashboard within the application 120.

TABLE 20

| Feature/Functionality | Description |
|---|---|
| Audience Segmentation & | The application allows event organizers to segment their |
| Custom Advertisement | past attendees based on various criteria such as, but not |
| Campaigns | limited to, interest areas, event engagement, attendee |
| | behavior, etc. For example, in one embodiment, the |
| | application provides an event management dashboard |
| | where event organizers can filter attendees and create |
| | customized advertisement campaigns, allowing them to |
| | send highly targeted push notifications for future events, |
| | special offers, or relevant content. |
| Automated Drip | The application offers automated drip notification |
| Notification Campaigns | campaigns for different stages post-event, such as thank |
| | you messages, reminders for future events, or early-bird |
| | offers. For example, in one embodiment, the application |
| | provides event organizers with a user-friendly interface to |
| | create and schedule these campaigns, with templates they |
| | can customize for different purposes. |
| Incentivize Returning | The application enables event organizers to send push |
| Attendees | notifications with exclusive incentives, such as discounts |
| | or early access, to encourage past attendees to register |
| | again for their events. For example, in one embodiment, |
| | the application Includes a built-in promotion manager that |
| | tracks the performance of different incentives, providing |
| | insights into which offers are driving the most |
| | conversions. |
| Personalized Engagement | The application utilizes an AI-powered recommendation |
| Notifications | engine to send personalized notifications to past |
| | attendees, suggesting events or sessions they are most |
| | likely to be interested in based on previous behavior. For |
| | example, in one embodiment, the application sets up |
| | automatic, AI-driven notifications that trigger when new |
| | events are listed that match an attendee's past interests. |
| | The application then provides event organizers metrics to |
| | see how personalized notifications impact registration |
| | rates. |
| Feedback Loop for Event | The application offers push notifications that include |
| Improvement | surveys or polls, allowing event organizers to gather |
| | feedback from past attendees to improve future events. |
| | For example, in one embodiment, the application allows |
| | event organizers to create short surveys directly in-app, |
| | and send the surveys as push notifications. The |
| | application also allows event organizers to view analytics |
| | on feedback from past attendees for actionable insights. |
| Exclusive Content | The application utilizes push notifications to deliver |
| Delivery via Push | exclusive content (e.g., event highlights, keynote speaker |
| | recordings, exclusive industry reports) to past attendees. |
| | For example, in one embodiment, the application |
| | provides event organizers with a content library where |
| | they can upload content and schedule notifications to |
| | share the uploaded content, giving them a way to continue |
| | engagement post-event. |
| Networking Re- | The application encourages past attendees to reconnect or |
| Engagement | continue conversations with people they met during |
| | previous events, using reminders and networking |
| | prompts. For example, in one embodiment, the |
| | application allows event organizers to send notifications |
| | that: (1) highlight key professional connections past |
| | attendees made, and (2) offer to re-engage the past |
| | attendees with the key professional connections through |
| | the application's networking features. |
| Sponsored Push | The application allows event organizers to include |
| Notifications for | sponsored content in their push notifications for specific |
| Monetization | partners or vendors from their event, helping them to |
| | further monetize engagement. For example, in one |
| | embodiment, the application offers event organizers a |
| | sponsored notification feature that provides them with |
| | space within the application where they can add vendor |
| | messages or advertisements to increase |
| | exposure/visibility for their events. The application can |
| | provide the event organizers with advanced data analytics |
| | to show the value of this increased exposure/visibility. |
| Gamified Engagement | The application offers a gamified system where attendees |
| Campaigns | to an event earn points for interacting with event content, |
| | opening notifications, registering for new events, etc. For |
| | example, in one embodiment, the application offers event |
| | organizers the gamified system which they can use to |
| | reward attendees for various actions via push |
| | notifications, encouraging ongoing interaction. Attendees |
| | may redeem rewards at the next event they attend. |
| Performance Analytics for | The application offers event organizers advanced data |
| Push Campaigns | analytics on performance of its push notification |
| | campaigns, such as open rates, click-through rates, and |
| | resulting registrations. For example, in one embodiment, |
| | the event management dashboard integrates a reporting |
| | tool that shows the effectiveness of each push notification |
| | campaign, helping them refine their messaging strategy |
| | over time. |
| Integration with Other | The application allows event organizers to synchronize |
| Marketing Channels | their push notification campaigns with email and social |
| | media campaigns, providing a unified messaging strategy. |
| | For example, in one embodiment, the event management |
| | dashboard offers a “campaign scheduler” where event |
| | organizers can coordinate cross-channel promotions and |
| | determine when push notifications are aligned with other |
| | touchpoints, ensuring maximum impact. |
| White-Labeled Push | The application allows event organizers to brand their |
| Notification Service | push notifications campaigns with their own branding, |
| | making the messages feel more integrated with their |
| | brand. For example, in one embodiment, the event |
| | management dashboard offers event organizers who are |
| | premium clients (e.g., subscribed to enterprise package) a |
| | branding tool which they can utilize to add their logo and |
| | other trademarks to customize the style of their push |
| | notifications such that it reflects their identity. |

In one embodiment, the application 120 offers event organizers different subscription packages representing different tiers of access to features/functionalities of the application 120 they may utilize (e.g., the features/functionalities shown in Table 20). For example, event organizers who subscribe to a basic package have access to features/functionalities such as mass push notifications to all past attendees. As another example, event organizers who subscribe to a professional package have access to features/functionalities the basic package provides, as well as additional features/functionalities, such as segmentation, personalized engagement, and advanced data analytics. As another example, event organizers who subscribe to an enterprise package have access to all features/functionalities available provided by the application 120, including branded notifications, AI personalization, and cross-channel integration. In one embodiment, the application 120 offers event organizers an initial consultation to help them understand how push notifications promote re-engagement from their past attendees, ultimately improving attendee retention and growing the success of their events. For example, the application 120 may present them with case studies and testimonials, i.e., real-life examples of other event organizers who successfully used push notifications through the application 120 to re-engage their audience and drive event registrations. The application 120 may also provide onboarding support to event organizers for setting up their initial push notification campaigns.

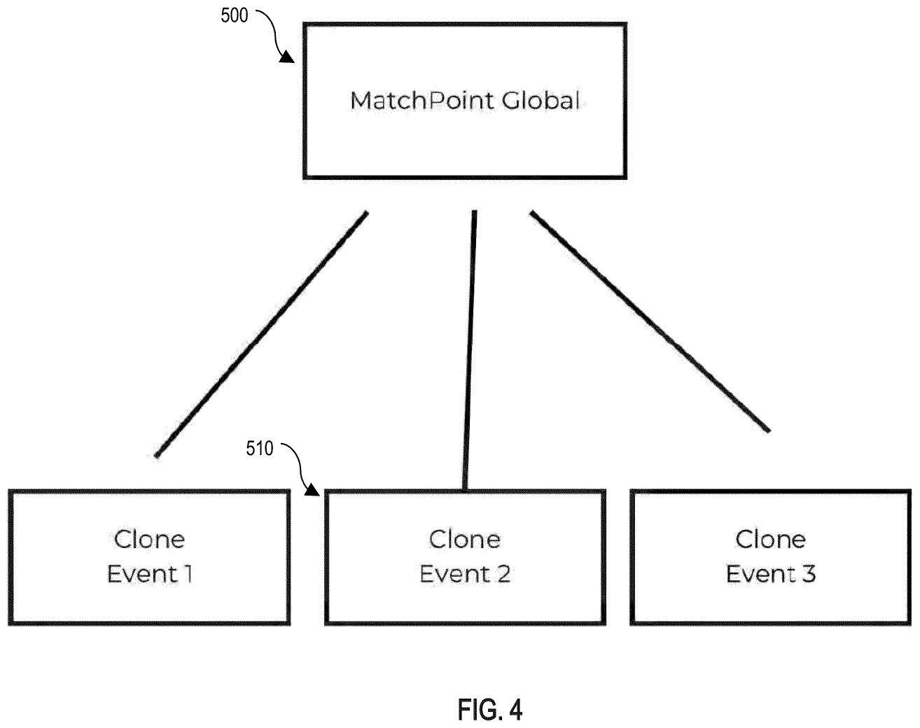

FIG. 4 illustrates an example wireframe of the AI-driven professional networking platform, in one or more embodiments. In one embodiment, a global structure 500 provides a central source of login to the platform. A cloning process, such as Global Assembly Cache, is utilized to create a clone event app 510 for each event whose event organizer purchased use of the platform for their event (e.g., Clone Event 1 is created for Event, Clone Event 2 is created for Event 2, Clone Event 3 is created for Event 3, etc.). Attendees (e.g., professionals, etc.) at an event can access, via their client-side professional networking application 120, a particular clone event app 510 created for the event using a special code.

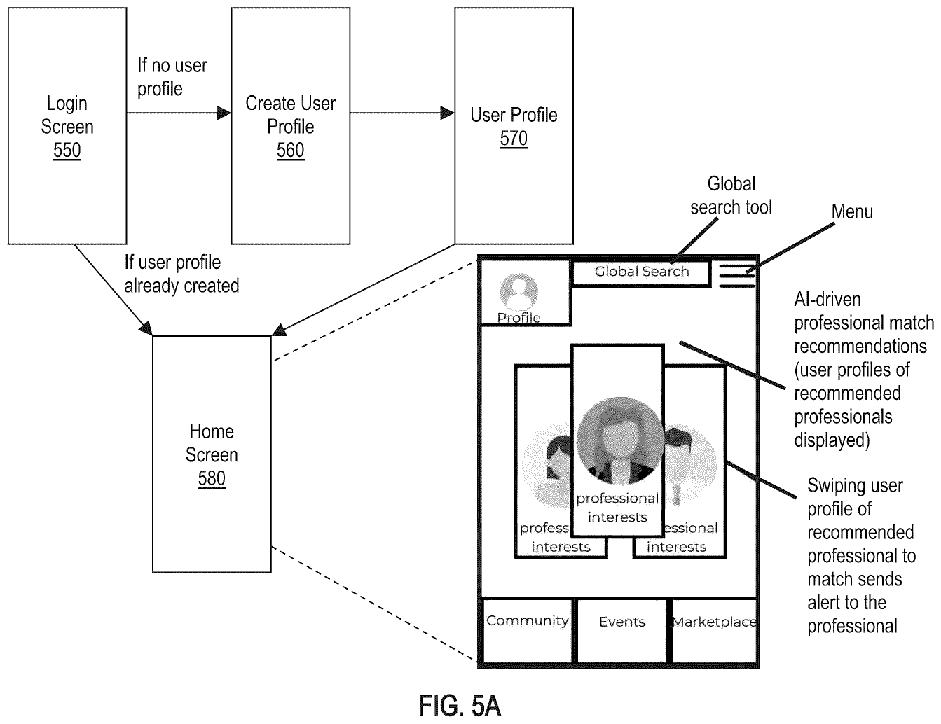

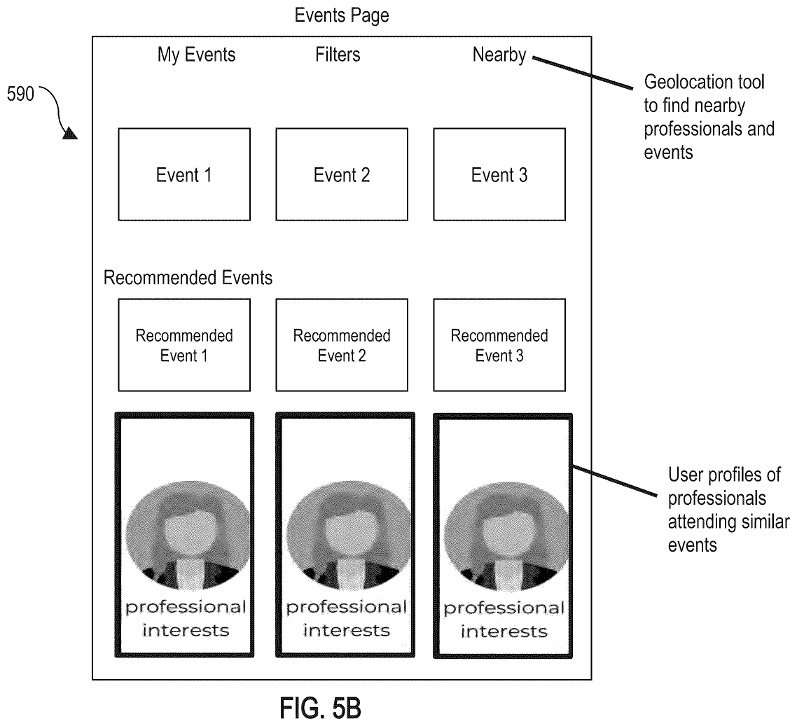

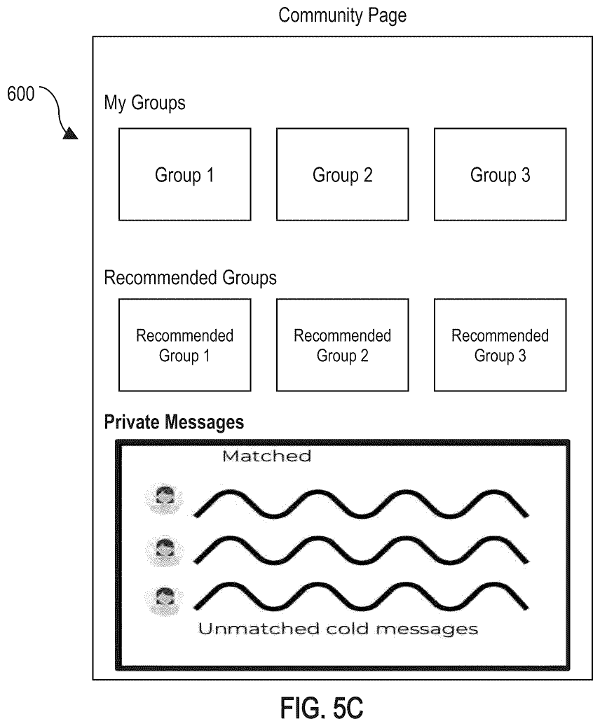

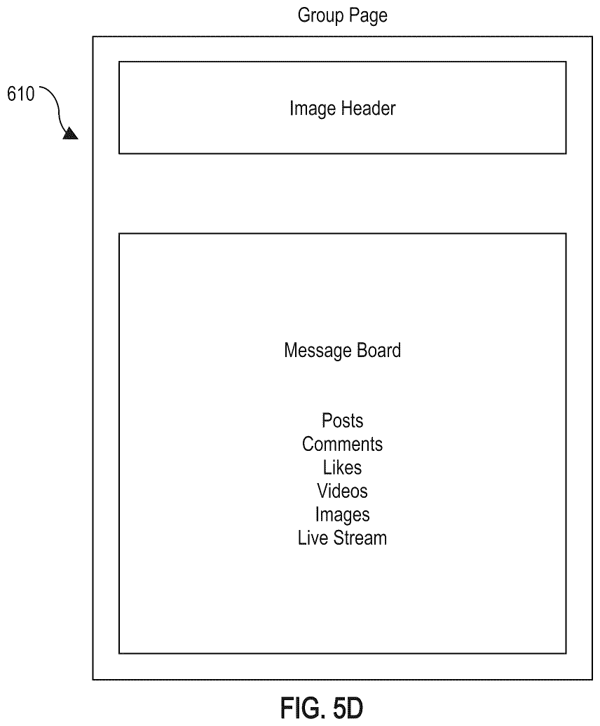

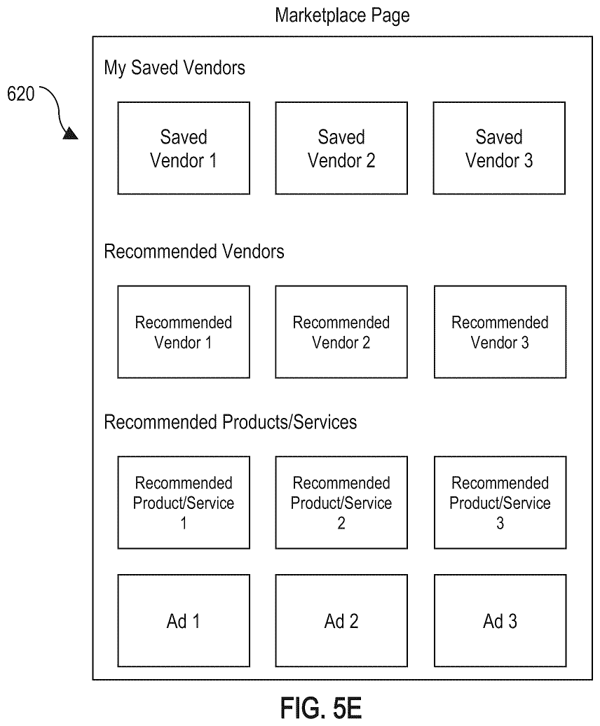

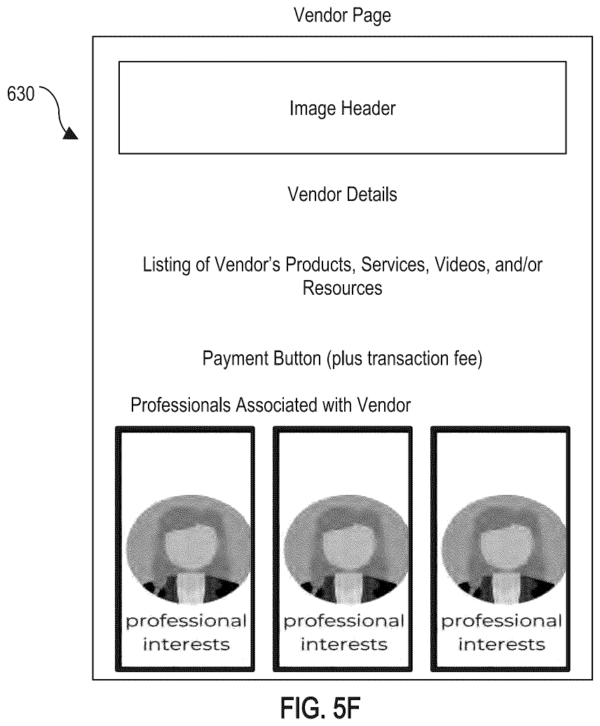

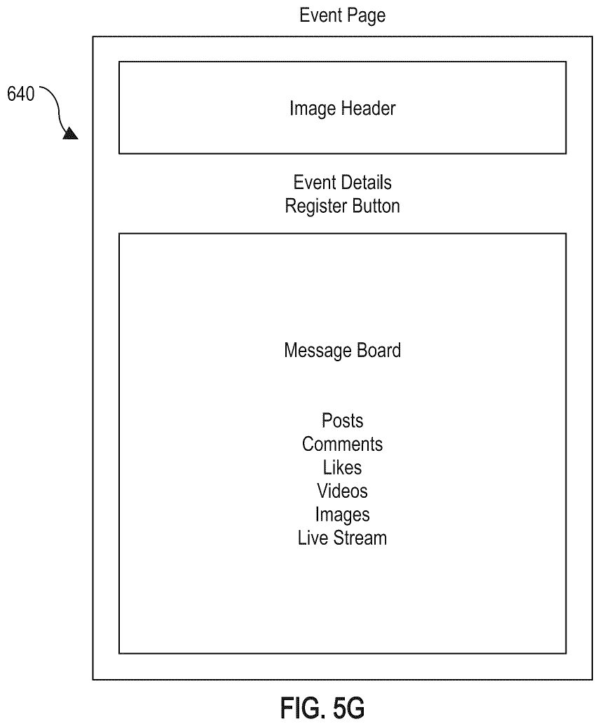

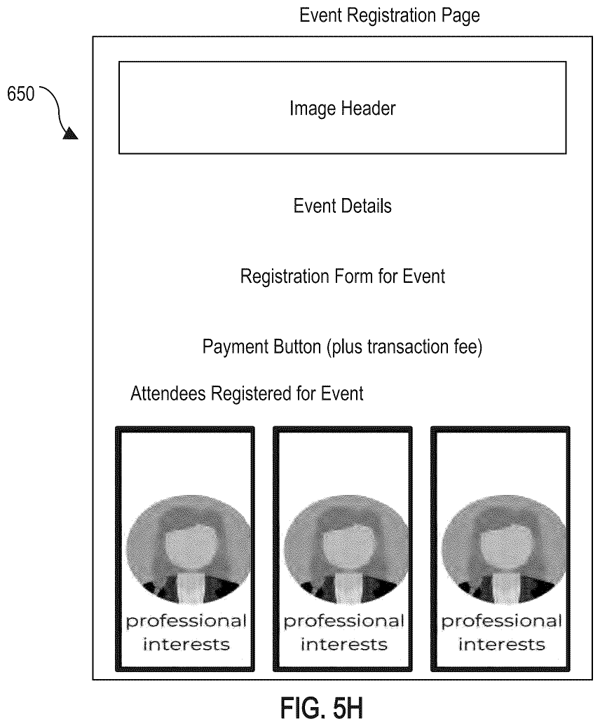

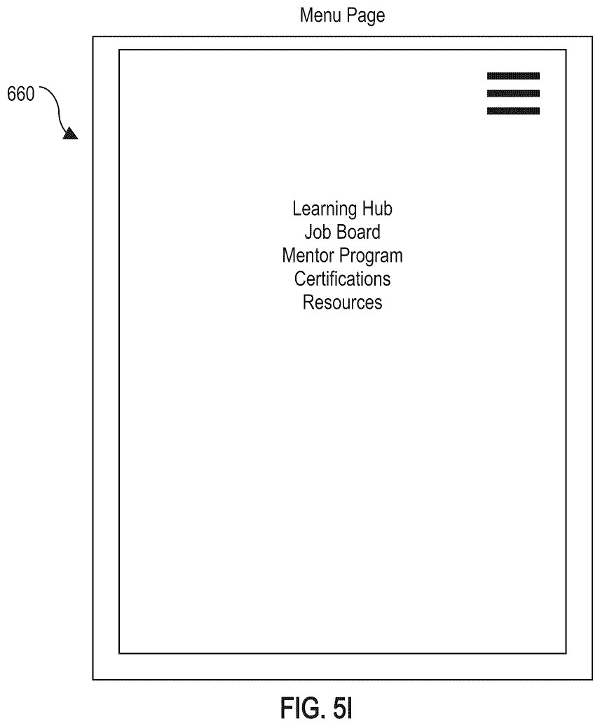

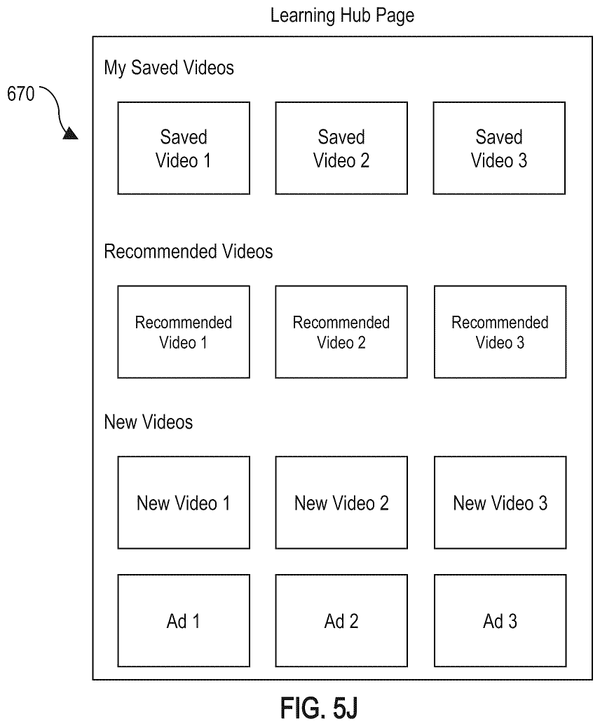

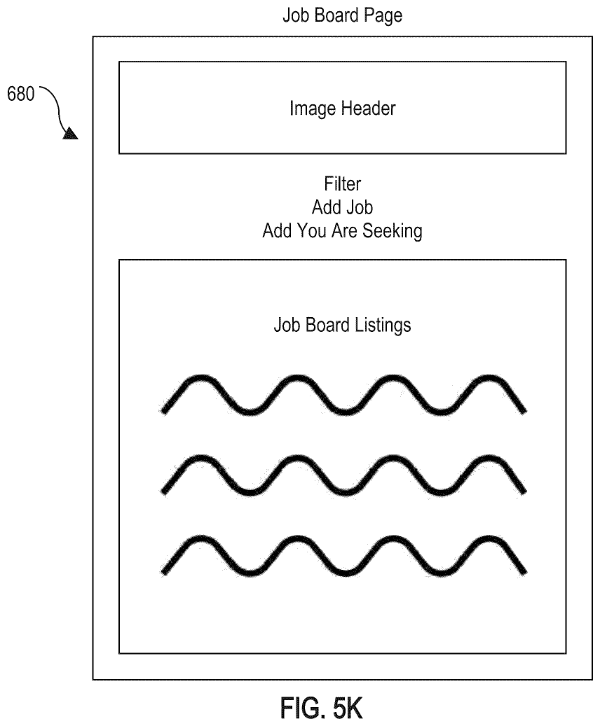

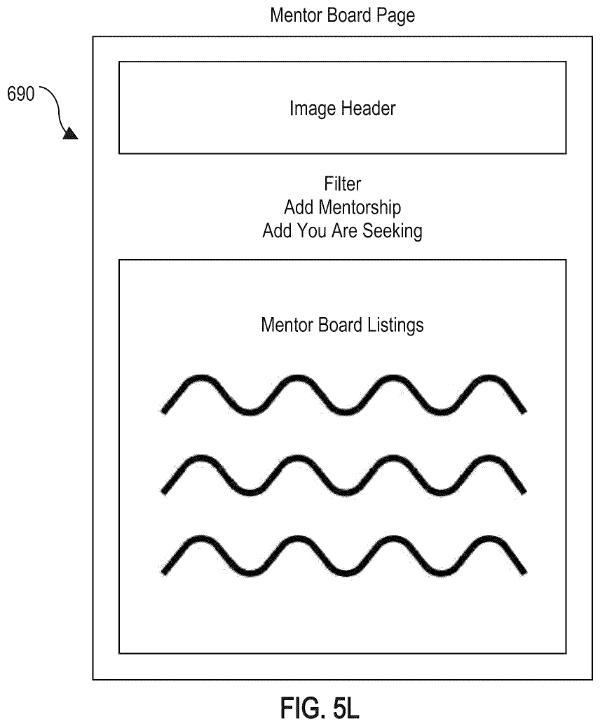

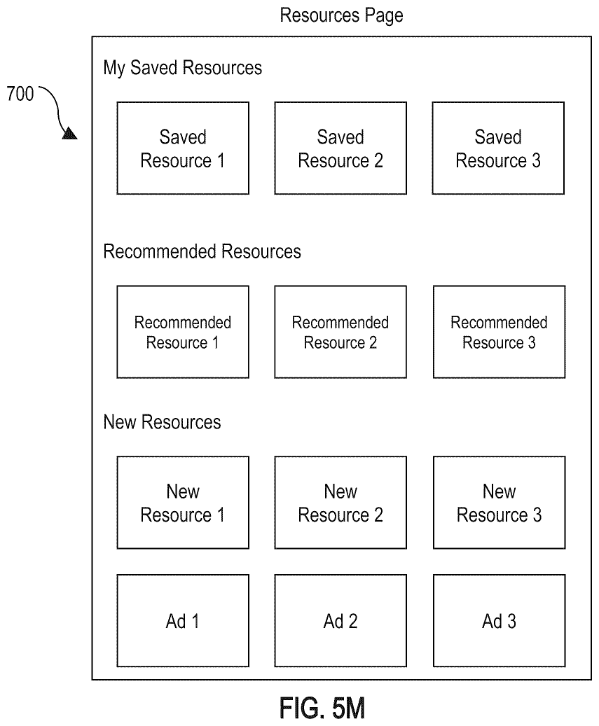

FIGS. 5A-5M illustrate a first set of example GUIs displayed within the application 120, in one or more embodiments.

FIG. 5A illustrates an example sequence of GUIs within the application 120 a user 10 is presented with at login, in one or more embodiments. If the user 10 is logged out of the application 120, the user 10 is presented with a first GUI 550 representing a login screen. If the user 10 does not have a user profile yet, the user 10 is presented with a second GUI 560 after logging in. The second GUI allows the user 10 to create a user profile which the user 10 can then view via a third GUI 570 representing the user profile. If the user 10 is satisfied with the user profile, the user 10 is presented with a fourth GUI 580 representing a home screen.

If the user 10 already has a user profile, the user 10 is presented with the home screen 580 instead after logging in.

As shown in FIG. 5A, the home screen 580 includes a region displaying AI-driven professional match recommendations (e.g., from the matchmaking algorithm 251) for the user 10. Each professional match recommendation includes a user profile of a recommended professional that the user 10 can swipe to match. The platform will send an alert to the recommended professional whose user profile the user 10 swiped to match.

As shown in FIG. 5A, the home screen 580 includes buttons that the user 10 can interact with such as, but not limited to, a first button to access the user's 10 user profile, a second button to access a global search tool the user 10 can utilize to search (e.g., for other users 10, events, etc.), a third button to access a menu page listing various features/functionalities of the application 120 that the user 10 can access, a fourth button to access a community page, a fifth button to access an events page, and a sixth button to access a marketplace page.

FIG. 5B illustrates an example events page 590 displayed within the application 120, in one or more embodiments. The events page 590 includes a first listing of upcoming events, and a second listing of recommended similar events for the user 10 which some professionals (e.g., past professional matches or professional connections) are attending.

As shown in FIG. 5B, the events page 590 includes buttons that the user 10 can interact with such as, but not limited to, a first button to access a listing of events the user 10 has registered for, a second button to access one or more filters, and a third button to access a geolocation tool that enables the user 10 to find nearby professionals and events.

FIG. 5C illustrates an example community page 600 displayed within the application 120, in one or more embodiments. The community page 600 includes a first listing of groups a user 10 is a member of, and a second listing of recommended groups for the user 10 to join. The community page 600 also provides a snapshot of private messages with potential professional matches that the user 10 either successfully or unsuccessfully matched with.

FIG. 5D illustrates an example group page 610 displayed within the application 120, in one or more embodiments. The group page 610 includes a message board where users 10 who are members of a group can post to, comment on, share content to (e.g., videos, images, livestreams), and engage (e.g., likes) with posts, comments, and shared content of other users 10 who are also members of the same group.

FIG. 5E illustrates an example marketplace page 620 displayed within the application 120, in one or more embodiments. The marketplace page 620 includes a first listing of vendors a user 10 has saved, a second listing of recommended vendors for the user 10, and a third listing of recommended products/services for the user 10.

In one embodiment, the application 120 can display rotating advertisements (e.g., sponsored content) on one or more pages/screens displayed within the application 120, such as the marketplace page 620 (see Ad 1, Ad 2, Ad 3, . . . ).

FIG. 5F illustrates an example vendor page 630 displayed within the application 120, in one or more embodiments. The vendor page 630 includes vendor details of a vendor, a listing of products, services, videos, and/or resources offered by the vendor, and a listing of user profiles for professionals associated with the vendor (e.g., sales representatives). The vendor page includes a payment button that a user 10 can utilize when purchasing the vendor's products or services.

FIG. 5G illustrates an example event page 640 displayed within the application 120, in one or more embodiments. The event page 640 includes event details of an event, and a button a user 10 may interact with to register for the event. The event page 640 also includes a message board where users 10 who attend the event can post to, comment on, share content to (e.g., videos, images, livestreams), and engage (e.g., likes) with posts, comments, and shared content of other users 10 who also attend the same event.

FIG. 5H illustrates an example event registration page 650 displayed within the application 120, in one or more embodiments. The event registration page 650 includes event details of an event, a registration form including one or more fields that are either automatically or manually populated with information relating to a user 10 registering for the event, a payment button the user 10 can utilize to pay for registration fees or a ticket to the event, and a listing of user profiles for other users 10 who are registered for the same event.

FIG. 5I illustrates an example menu page 660 displayed within the application 120, in one or more embodiments. The menu page 660 includes a listing of various features/functionalities of the application 120 that a user 10 can access.

FIG. 5J illustrates an example learning hub page 670 displayed within the application 120, in one or more embodiments. The learning hub page 670 includes a first listing of videos from vendors a user 10 has saved, a second listing of recommended videos from vendors for the user 10, and a third listing of new videos promoting products/services from vendors that the user 10 has previously saved videos from.

In one embodiment, the application 120 can display rotating advertisements (e.g., sponsored content) on one or more pages/screens displayed within the application 120, such as the learning hub page 670 (see Ad 1, Ad 2, Ad 3, . . . ).

FIG. 5K illustrates an example job board page 680 displayed within the application 120, in one or more embodiments. The job board page 680 includes a listing of available jobs that are relevant to a user 10. The job board page 680 also includes buttons the user 10 may interact with, such as, but not limited to, a first button to access one or more filters for the listing, a second button for the user 10 to add an available job to the listing, and a third button for the user 10 to indicate that they are looking for a job. In one embodiment, the system 200 provides an AI agent that can assist the user 10 with analyzing available jobs in the listing that are most suitable for the user 10.

FIG. 5L illustrates an example mentor board page 690 displayed within the application 120, in one or more embodiments. The mentor board page 690 includes a listing of available mentors that are relevant to a user 10. The mentor board page 690 also includes buttons the user 10 may interact with, such as, but not limited to, a first button to access one or more filters for the listing, a second button for the user 10 to add an available mentor (e.g., themselves) to the listing, and a third button for the user 10 to indicate that they are looking for a mentor. In one embodiment, the system 200 provides an AI agent that can assist the user 10 with analyzing available mentors in the listing that are most suitable for the user 10.

FIG. 5M illustrates an example resources page 700 displayed within the application 120, in one or more embodiments. The resources page 700 includes a first listing of resources a user 10 has saved, a second listing of recommended resources for the user 10, and a third listing of new resources (e.g., from vendors that the user 10 has previously saved resources from).

In one embodiment, the application 120 can display rotating advertisements (e.g., sponsored content) on one or more pages/screens displayed within the application 120, such as the resources page 700 (see Ad 1, Ad 2, Ad 3, . . . ).

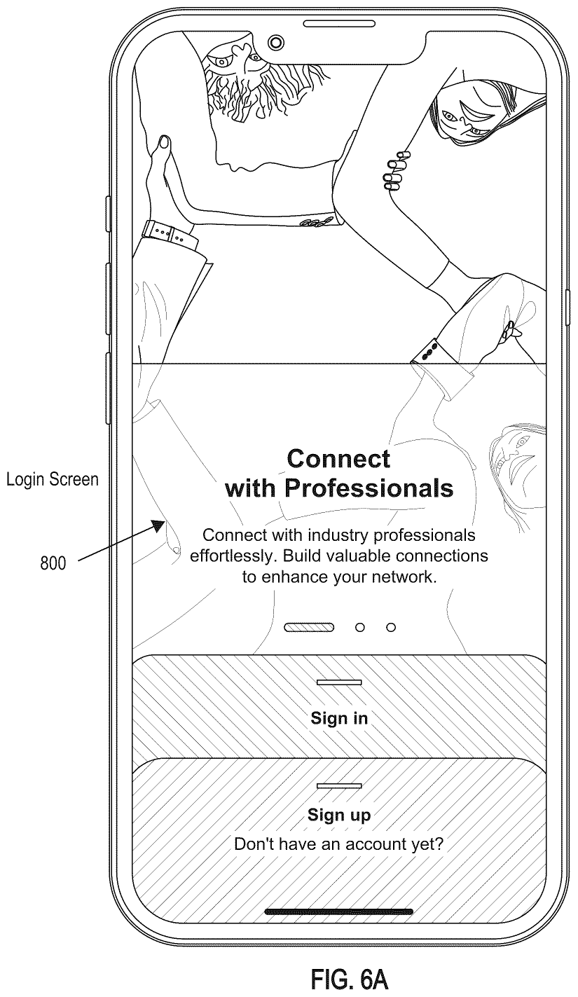

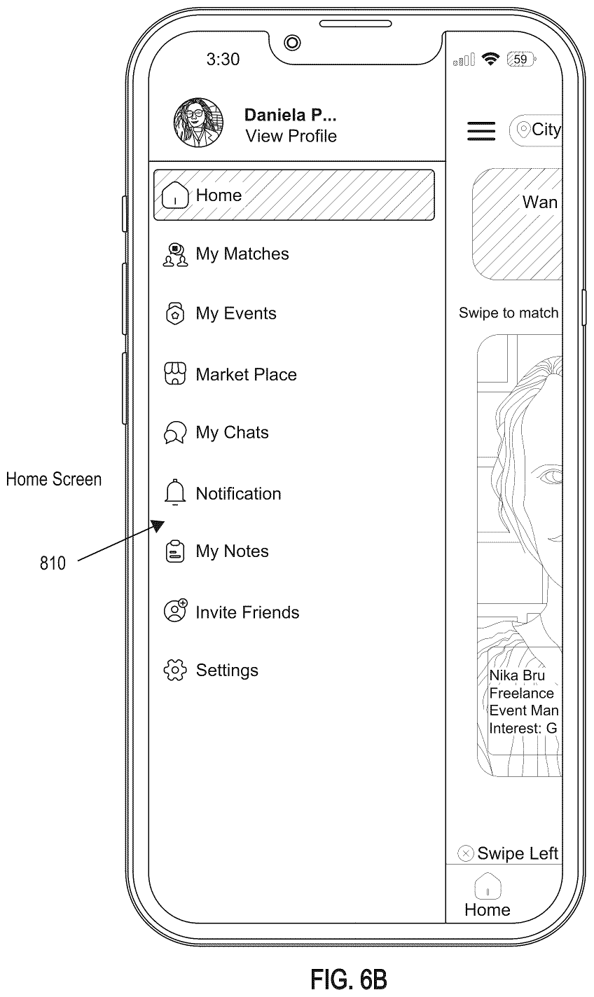

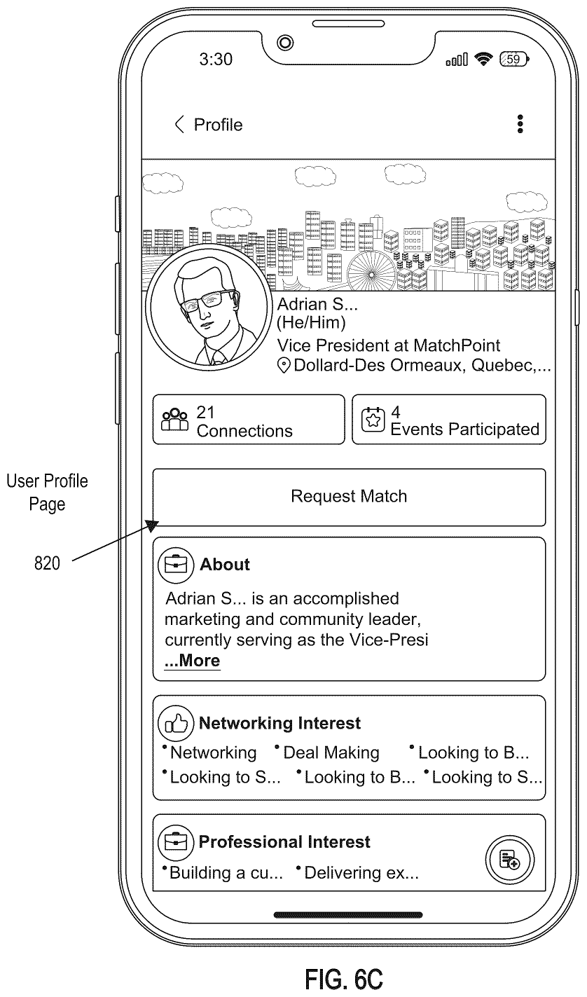

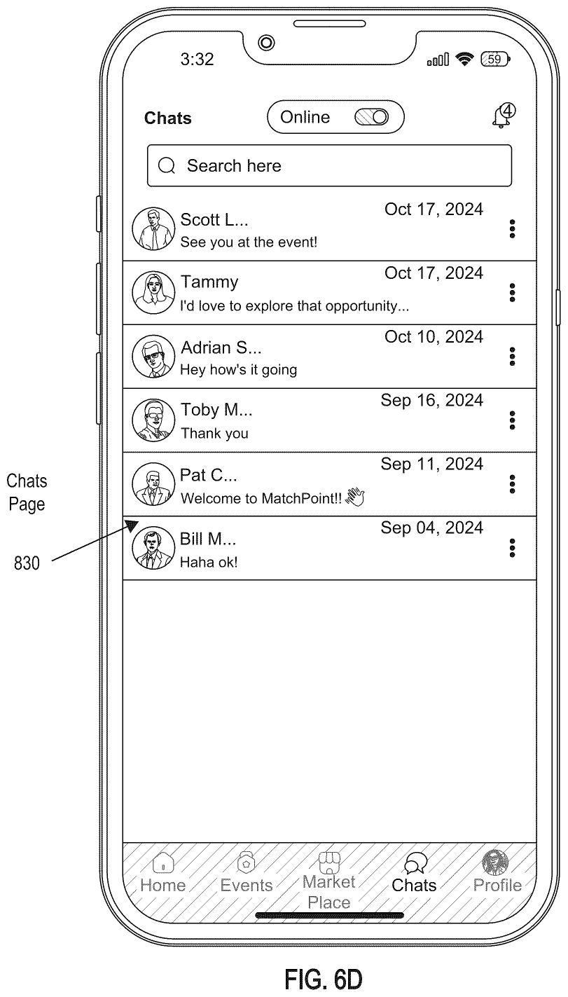

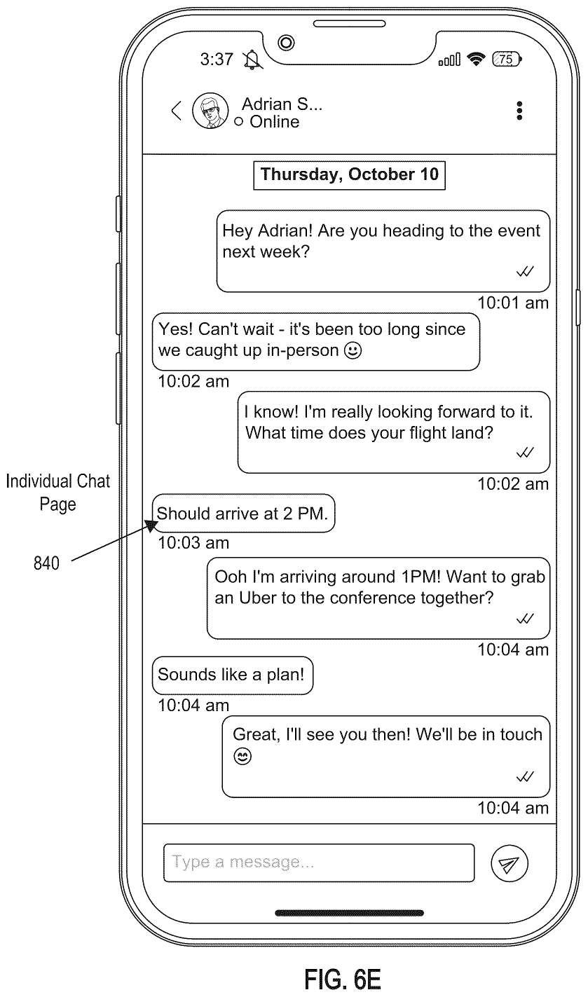

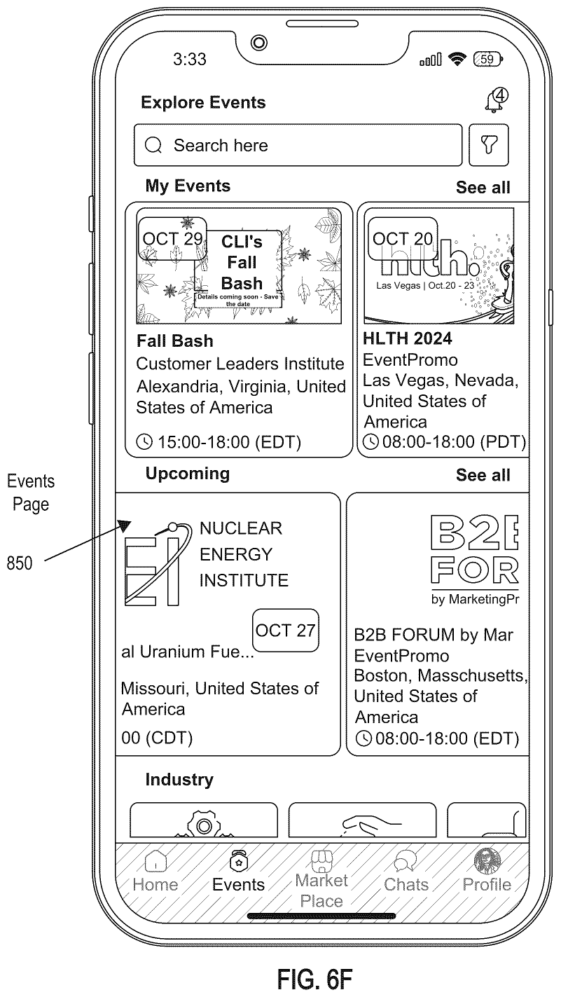

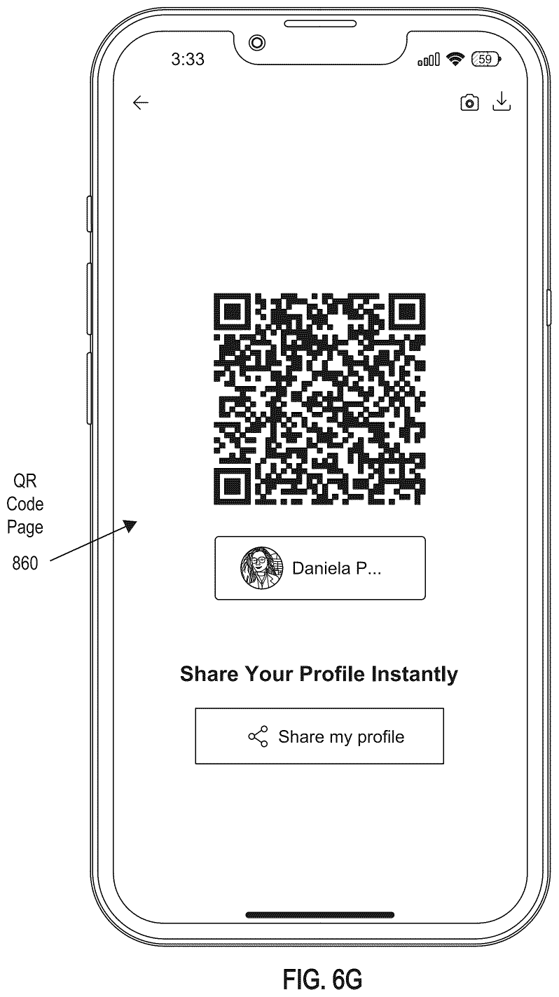

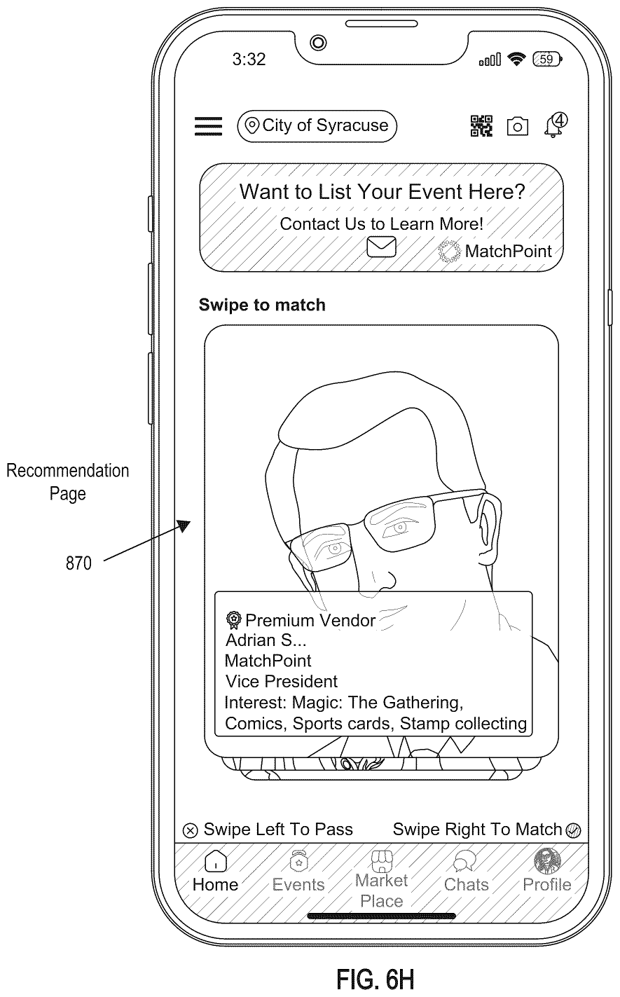

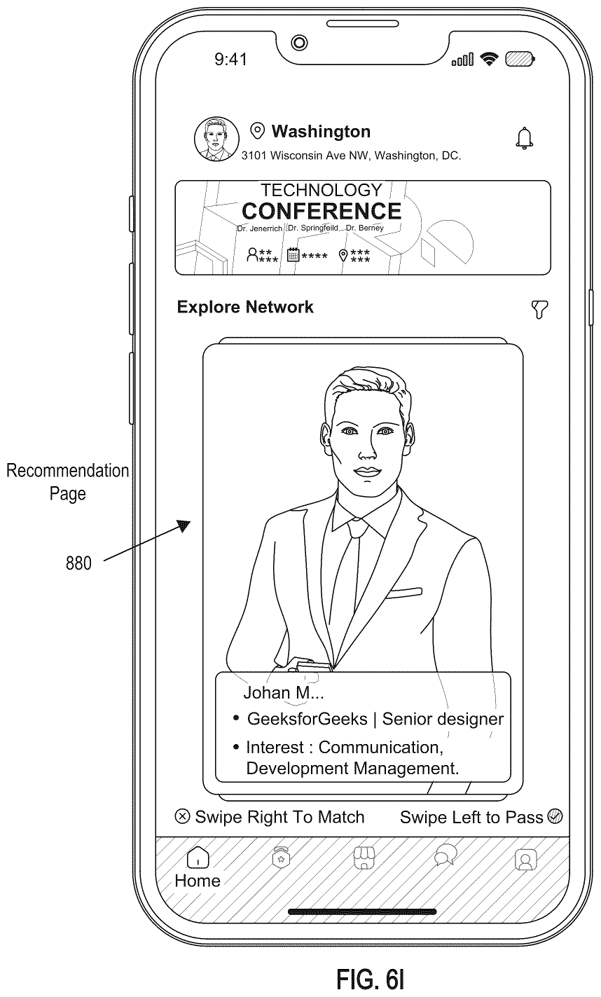

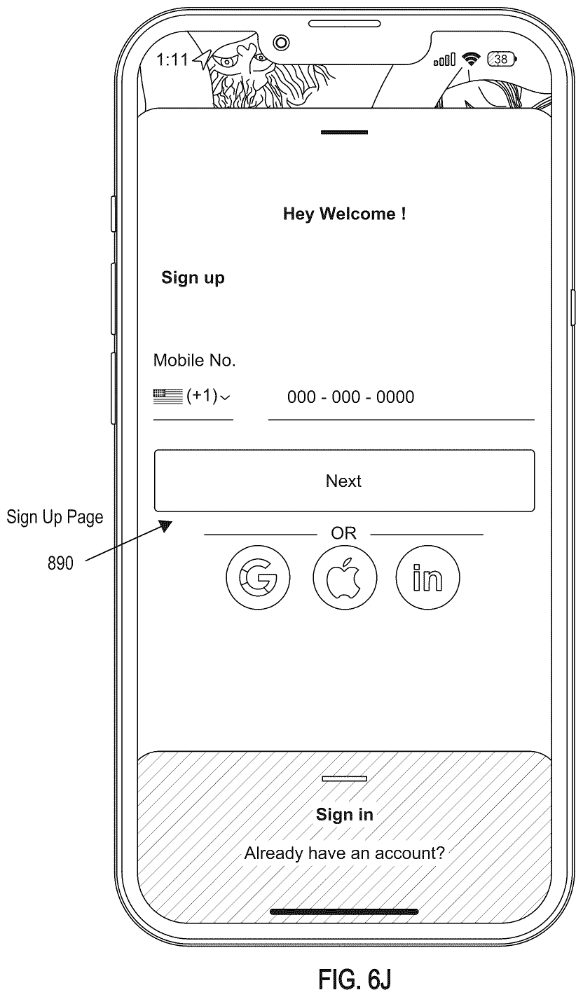

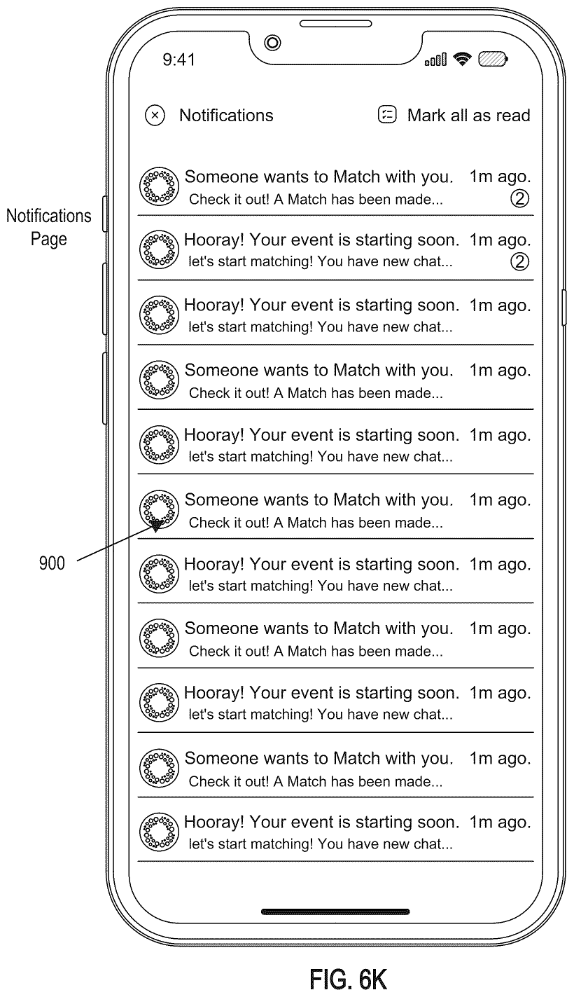

FIGS. 6A-6K illustrate a second set of example GUIs displayed within the application 120, in one or more embodiments. Specifically, FIG. 6A illustrates an example login screen 800 displayed within the application 120, in one or more embodiments. FIG. 6B illustrates an example home screen 810 displayed within the application 120, in one or more embodiments. FIG. 6C illustrates an example user profile page 820 displayed within the application 120, in one or more embodiments.

FIG. 6D illustrates an example chats page 830 displayed within the application 120, in one or more embodiments. The chats page 830 lists chats between a user 10 and other users 10 the user 10 has interacted with via messages/chats.

FIG. 6E illustrates an example individual chat page 840 displayed within the application 120, in one or more embodiments. The individual chat page 840 displays a chat between a user 10 and another user 10 the user 10 has interacted with via messages/chat.

FIG. 6F illustrates an example events page 850 displayed within the application 120, in one or more embodiments.

FIG. 6G illustrates an example QR code page 860 displayed within the application 120, in one or more embodiments. Each user 10 is assigned a unique QR code which they can provide for scanning to other users 10 to share their user profile with the other users 10. In one embodiment, QR codes assigned to users 10 provide more embedded information and details, allowing the users 10 the ability to register for events, event ID/badge scanning, data transfer to vendors, etc.

FIG. 6H illustrates an example recommendation page 870 displayed within the application 120, in one or more embodiments. The recommendation page 870 displays a user profile for a potential professional match that a user 10 can either accept or dismiss via swiping.

FIG. 6I illustrates another example recommendation page 880 displayed within the application 120, in one or more embodiments. The recommendation page 880 displays a user profile for a potential professional match that a user 10 can either accept or dismiss via swiping.

FIG. 6J illustrates an example sign up page 890 displayed within the application 120, in one or more embodiments. The sign up page 890 allows a new user 10 to sign up for/register with the platform.

FIG. 6K illustrates an example notifications page 900 displayed within the application 120, in one or more embodiments. The notifications page 900 displays a listing of alerts and notifications for the user 10.

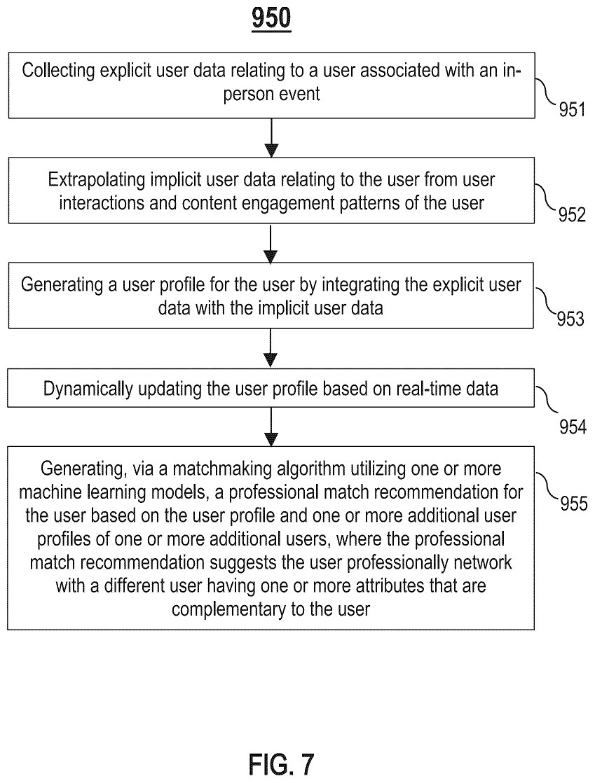

FIG. 7 is a flowchart of an example process 950 for AI-driven professional networking, in one or more embodiments. Process block 951 includes collecting explicit user data relating to a user associated with an in-person event. Process block 952 includes extrapolating implicit user data relating to the user from user interactions and content engagement patterns of the user. Process block 953 includes generating a user profile for the user by integrating the explicit user data with the implicit user data. Process block 954 includes dynamically updating the user profile based on real-time data. Process block 955 includes generating, via a matchmaking algorithm utilizing one or more machine learning models, a professional match recommendation for the user based on the user profile and one or more additional user profiles of one or more additional users, where the professional match recommendation suggests the user professionally network with a different user having one or more attributes that are complementary to the user.

In one embodiment, process blocks 951-955 may be performed utilizing one or more components of the system 200 and/or the application 120.

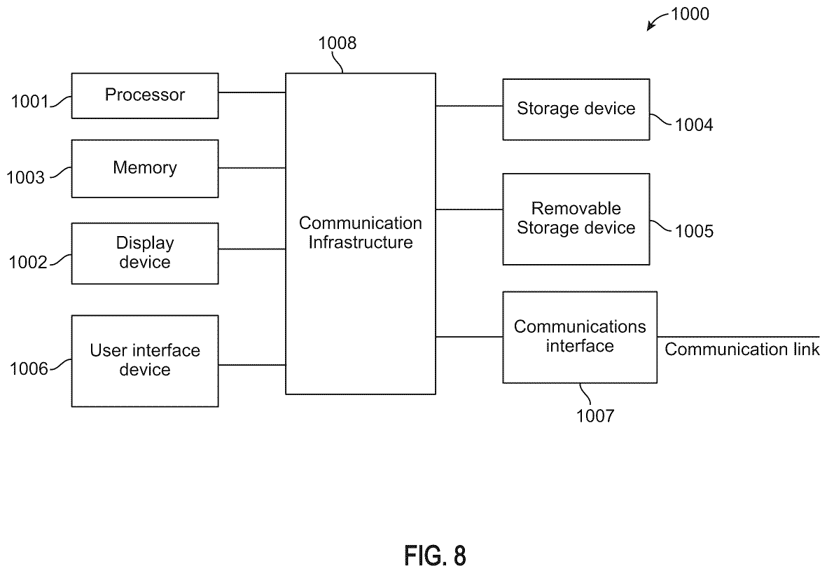

FIG. 8 is a high-level block diagram showing an information processing system comprising a computer system 1000 useful for implementing the disclosed embodiments. The computer system 1000 includes one or more processors 1001, and can further include an electronic display device 1002 (for displaying video, graphics, text, and other data), a main memory 1003 (e.g., random access memory (RAM)), storage device 1004 (e.g., hard disk drive), removable storage device 1005 (e.g., removable storage drive, removable memory module, a magnetic tape drive, optical disk drive, computer readable medium having stored therein computer software and/or data), user interface device 1006 (e.g., keyboard, touch screen, keypad, pointing device), and a communication interface 1007 (e.g., modem, a network interface (such as an Ethernet card), a communications port, or a PCMCIA slot and card). The main memory 1003 may store instructions that when executed by the one or more processors 1001 cause the one or more processors 1001 to perform one or more process blocks of the process 950.

The communication interface 1007 allows software and data to be transferred between the computer system and external devices. The system 1000 further includes a communications infrastructure 1008 (e.g., a communications bus, cross-over bar, or network) to which the aforementioned devices/modules 1001 through 1007 are connected.

Information transferred via communications interface 1007 may be in the form of signals such as electronic, electromagnetic, optical, or other signals capable of being received by communications interface 1007, via a communication link that carries signals and may be implemented using wire or cable, fiber optics, a phone line, a cellular phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process. In one embodiment, processing instructions for one or more process blocks of process 950 (FIG. 7) may be stored as program instructions on the memory 1003, storage device 1004 and the removable storage device 1005 for execution by the processor 1001.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “cmodule” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A method comprising:
collecting explicit user data relating to a user associated with an in-person event;
extrapolating implicit user data relating to the user from user interactions and content engagement patterns of the user;
generating a user profile for the user by integrating the explicit user data with the implicit user data;
dynamically updating the user profile based on real-time data; and
generating, via a matchmaking algorithm utilizing one or more machine learning models, a professional match recommendation for the user based on the user profile and one or more additional user profiles of one or more additional users, wherein the professional match recommendation suggests the user professionally network with a different user having one or more attributes that are complementary to the user.

2. The method of claim 1, wherein the one or more machine learning models include one or more deep learning models.

3. The method of claim 2, wherein the one or more deep learning models include one or more large language models (LLMs).

4. The method of claim 1, wherein the real-time data includes at least one of user preferences of the user, user feedback from the user, communication patterns of the user, or emerging industry or professional trends in an industry or profession relevant to the user.

5. The method of claim 1, further comprising:
identifying one or more intricate patterns and correlations across the user profile and the one or more additional user profiles.

6. The method of claim 1, wherein the implicit user data includes user behaviors and user preferences of the user.

7. The method of claim 1, further comprising:
utilizing the one or more machine learning models to predict emerging industry or professional trends in an industry or profession relevant to the user.

8. The method of claim 1, further comprising:
collecting user feedback from the user; and
refining the matchmaking algorithm based on the user feedback.

9. The method of claim 1, wherein the one or more additional users are associated with the same event or a similar event.

10. The method of claim 1, further comprising:
generating an interactive location-based heatmap of the event for display to the user, wherein the heatmap shows the location of the different user.

11. The method of claim 1, further comprising:
scheduling a meeting or other networking activity between the user and the different user.

12. The method of claim 1, wherein the user is present at the event.

13. A system comprising:
at least one processor; and
a non-transitory processor-readable memory device storing instructions that when executed by the at least one processor causes the at least one processor to perform operations including:
collecting explicit user data relating to a user associated with an in-person event;
extrapolating implicit user data relating to the user from user interactions and content engagement patterns of the user;
generating a user profile for the user by integrating the explicit user data with the implicit user data;
dynamically updating the user profile based on real-time data; and
generating, via a matchmaking algorithm utilizing one or more machine learning models, a professional match recommendation for the user based on the user profile and one or more additional user profiles of one or more additional users, wherein the professional match recommendation suggests the user professionally network with a different user having one or more attributes that are complementary to the user.

14. The system of claim 13, wherein the one or more machine learning models include one or more deep learning models.

15. The system of claim 14, wherein the one or more deep learning models include one or more large language models (LLMs).

16. The system of claim 13, wherein the real-time data includes at least one of user preferences of the user, user feedback from the user, communication patterns of the user, or emerging industry or professional trends in an industry or profession relevant to the user.

17. The system of claim 13, wherein the operations further include:
utilizing the one or more machine learning models to predict emerging industry or professional trends in an industry or profession relevant to the user.

18. The system of claim 13, wherein the operations further include:
generating an interactive location-based heatmap of the event for display to the user, wherein the heatmap shows the location of the different user.

19. The system of claim 13, wherein the operations further include:
scheduling a meeting or other networking activity between the user and the different user.

20. A non-transitory processor-readable medium that includes a program that when executed by a processor performs a method comprising:
collecting explicit user data relating to a user associated with an in-person event;
extrapolating implicit user data relating to the user from user interactions and content engagement patterns of the user;
generating a user profile for the user by integrating the explicit user data with the implicit user data;
dynamically updating the user profile based on real-time data; and
generating, via a matchmaking algorithm utilizing one or more machine learning models, a professional match recommendation for the user based on the user profile and one or more additional user profiles of one or more additional users, wherein the professional match recommendation suggests the user professionally network with a different user having one or more attributes that are complementary to the user.
